(19) United States
(12) Patent Application Publication
(10) Pub. No.: US 2025/0353217 A1
(43) Pub. Date: Nov. 20, 2025

(54) HIGH PRESSURE MIXING HEAD FOR CONTINUOUSLY PRODUCING POLYMERIC FOAM

(71) Applicant: Afros S.p.A., Caronno Pertusella (IT)

(72) Inventors: Marco Volpato, Caronno Pertusella (IT); Maurizio Corti, Caronno Pertusella (IT); Raffaele Laera, Caronno Pertusella (IT); Pierangelo Olivieri, Caronno Pertusella (IT)

(73) Assignee: Afros S.p.A., Caronno Pertusella (IT)

(21) Appl. No.: 19/175,129

(22) Filed: Apr. 10, 2025

(30) Foreign Application Priority Data
May 17, 2024 (EP) 24176644.3

(51) Int. Cl. B29B 7/76; B29B 7/80

(52) U.S. Cl. CPC B29B 7/7694; B29B 7/7657; B29B 7/806

(57) ABSTRACT

A high pressure mixing head for continuously producing polymeric foam comprises a body including a mixing chamber and injectors for injecting two polymeric liquids. The mixing head also includes a delivery duct which is disposed transversely to the mixing chamber, wherein a rod is slidably received in an internal passageway of the delivery duct. An alternate delivery duct is also included. The delivery duct and the alternate delivery duct are in flow communication with the mixing chamber via a switchable flow connection, and a control unit is configured to control the switchable flow connection and the positions of the rods in the delivery duct and the alternate delivery duct such that flow from the output opening of the mixing chamber can be selectively directed either to the delivery duct or to the alternate delivery duct.

### CROSS-REFERENCE TO RELATED APPLICATION

The present application claims priority from European Patent Application No. 24176644.3, filed May 17, 2024, the entire disclosure of which is hereby incorporated by reference herein.

### BACKGROUND

High pressure mixing heads for two or more reactive polymeric liquids are in wide-spread use in various industries for delivering quantities of reactive mixtures in succession to fill mould cavities to produce articles by injection moulding or to fill cavities, for example between inner and outer walls of refrigerator housings, to provide thermal insulation structures.

Besides the step-wise delivery of metered quantities of reactive polymeric mixture, also referred to as delivering “shots” for filling moulds or other cavities, there are continuous production methods for thermal insulation layers, for example of polyurethane or phenolic foam, i.e. dispensing of the reactive mixture is only interrupted at the end of a production run or at the end of a shift when production is terminated. In these continuous production methods high pressure mixing heads are used to distribute the reactive polymeric mixture on a substrate (for example a web of paper or plastic foil being unrolled from a supply roll) below the mixing heads, wherein the substrate is continuously advanced by conveying the substrate for example in a double belt conveyer which, by conveying the substrate with the polymeric foam on it and by providing upright side walls on the substrate, serves to contain the distributed polymeric foam as a layer between the side walls on the substrate. After solidification of the continuous foam layer, the continuous layer is cut into panels of desired length.

To obtain good quality and homogeneity of the dispensed and expanded foam, and to be able to use high production speeds of the substrate conveyor (e.g. one (1) meter per second) it is preferred to use two or three mixing heads in parallel, which mixing heads are mounted next to each other in a row extending transversely to the moving direction of the substrate conveyor, wherein each of the mixing heads delivers a part of the polymeric foam that forms the foam layer on the advancing substrate.

In many cases so-called L-shaped mixing heads are used to obtain polymeric foam layers of improved quality, wherein often three such L-shaped mixing heads operate in a parallel arrangement transverse to the conveying direction.

The design of these L-shaped mixing heads, which are in fact not only used for continuous production, but also for step-wise injection molding processes, will be briefly explained with reference to the high pressure mixing head described in U.S. Pat. No. 4,332,335 A1 which discloses an early example of such mixing head. The preamble of claim 1 is based on this high pressure mixing head described in US 4 3323 335 A1. The high pressure mixing head comprises a body in which a cylindric mixing chamber and injectors are formed for injecting at least two polymeric liquids into the mixing chamber. The polymeric liquids are supplied in a stoichiometric ratio by specific pumps under high pressure to the injectors, the injector ending in a nozzle that is adjustable to set the pressures of the delivered adjusted flow rates, and are injected, via the injectors, under high pressure, such that the ejected jets collide and are intimately mixed in the mixing chamber under highly turbulent conditions to form a reactive polymeric mixture in a very short time, a few milliseconds, during the residence time of the reactive polymeric mixture in the mixing chamber, whereafter the polymeric mixture is expelled from an output opening of the mixing chamber. A spool is slidably received in the mixing chamber and is moveable in the mixing chamber in a longitudinal direction thereof, wherein in a retracted position, the spool does not extend up to the injectors and thus permits that the injectors inject jets of the polymeric liquids into the mixing chamber; in an advanced position the spool is advanced in the mixing chamber beyond the injectors towards the output opening such that the polymeric liquids are prevented from entering the mixing chamber and are returned to be recycled via recycling channels. For this purpose, the spool is provided with longitudinal grooves or channels in its surface which, in the advanced position of the spool, are positioned to receive and redirect the polymeric liquids from the injectors to recirculation lines which are in flow communication with specific containment tanks from which the above-mentioned pumps can be supplied.

Movement of the spool is driven by a pneumatic or hydraulic actuator connected to the spool, and the movement of the spool to the advanced position in which a front end face of the spool is disposed in the output opening of the mixing chamber also serves, besides terminating delivery of reactive polymeric mixture, the purpose of cleaning the mixing chamber by expelling any remaining material and residuals from the interior of the mixing chamber by the advancing front end face of the spool, wherein the advancing spool also scrapes off thin layer of reacted polymer from the inner surface of the mixing chamber. Thus, in a step-wise operation mode, when repeatedly quantities of the reactive mixture are delivered to a mould, the mixing chamber is cleaned at the end of each mould filling step when the spool is moved to the advanced position to terminate the delivery of reactive mixture.

The output opening of the mixing chamber merges into an internal passageway in a delivery duct which is connected to the mixing chamber such that the longitudinal axis of the cylindrical internal passageway of the delivery duct extends perpendicular to the longitudinal axis of the mixing chamber. This arrangement of a mixing chamber and of a (longer) transverse delivery duct is an “L-shaped” arrangement, and this is the reason why such mixing heads are referred to as L-shaped mixing heads. The function of the delivery duct is to reduce turbulence and to dissipate kinetic energy of the reactive polymeric mixture expelled from the mixing chamber, wherein the kinetic energy of the reactive mixture flow is reduced when the expelled reactive mixture jet is hitting the opposite wall of the internal passageway of the delivery duct, and it is partially bouncing back and partially diverted to the delivery duct passageway to gradually dissipate and reduce its kinetic energy while the reactive mixture is completely diverted into the transversely extending delivery duct. This calms down the reactive mixture flow while it is flowing down along the delivery duct to an output end of the delivery duct for dispensing the polymeric foam resulting from the reactive polymeric mixture. The delivery duct is, as the mixing chamber, also self-cleaning, and for that purpose is provided with a rod of complementary cross-sectional shape to the internal passageway of the delivery duct, wherein the rod is connected to a piston of an actuator configured to move the rod between retracted position in which the rod leaves the output opening of the mixing chamber open and an advanced position in which the rod is moved to extend all along the internal passageway for cleaning it by advancing and expelling any remaining material and residuals from the internal passageway of the delivery duct. When the rod is in the advanced position it closes the internal passageway of the delivery duct such that the delivery duct is blocked.

In the continuous production systems for thermal insulation layers, the output end of the delivery duct is typically connected to a replaceable distributor which divides the flow of the polymeric foam dispensed by each mixing head into multiple flows, thereby distributing the flow in a direction transverse to the moving direction of the substrate carrying the dispensed foam to better distribute the foam and form a layer of uniform thickness across the substrate. The distributor can, for example, be provided with a plurality of small holes generating multiple jets, or can be provided with fan-shaped dispensers that dispense the output material poured transversely to the direction of advancement to distribute the reactive liquid mixture as even as possible across the width of the substrate carrying the polymeric mixture layer.

While L-shaped mixing heads are self-cleaning, when they are operated to deliver individual shots of reactive mixture, as has been described above, problems arise when they are operated to continuously deliver reactive mixture: On internal surfaces of the delivery ducts of the mixing heads and on the internal and external surfaces of the replaceable distributors, in continuous processes, a layer of reacted polymeric resins forms which increases in thickness over the time up to a point at which the flow of the polymeric mixture through them is disturbed, which prevents a homogeneous distribution, and may even block one or more of the distribution channels in the distributor. The faster the formation of this reacted resin layers takes place, the shorter is the time period after which the continuous delivery operation has to be interrupted and a mixing head cleaning cycle and/or a replacement of the replaceable distributors must be carried out.

In more detail, in the chambers and ducts where the reacting liquids flow, they form a very thin layer of liquid adhering to the walls which is referred to as boundary layer. This boundary layer reacts and polymerizes over the time and solidifies. When dispensing proceeds for a long period as in continuous foaming systems and this layer is not removed by the movement of the cleaning organs (spool and self-cleaning rod of the delivery duct), the boundary layer accumulates and increases in thickness of reacted resin on the walls of the ducts.

This phenomenon occurs in principle along all ducts along which the reactive mixture flows, but it is accentuated in areas of the ducts where speed and turbulence of the flowing mixture are reduced. Consequently, over the time, the thickness of the reacted resin increases and deteriorates the flow conditions up to the point of generating problems with the continuity and homogeneity of the distribution of the polymeric foam deposited on the substrate.

This stratification or boundary layer growth phenomenon is the faster the slower the flow speed in the duct is and the greater the reactivity of the resins is.

In the mixing chamber where the jets generated by the injectors cause impacts on the walls of the mixing chamber, where turbulence of the injected resins is intensive and where mixing is not yet complete, this accumulation does not occur or occurs only in some limited areas so that the stratification of reacted resin is marginal and much slower than in the delivery duct and the distributors. The accumulation therefore mainly occurs along the internal passageway of the delivery duct and along the distributor ducts, and particularly occurs in areas of flow slowdowns due to changes in flow cross-section and direction.

As already mentioned, disposable and replaceable flow distributors are normally applied downstream of the self-cleaning delivery duct. After some time, accumulation of polymerized resin develops in these distributor ducts and the distributors must be replaced by new and clean distributors. To replace them, it is up to now necessary to interrupt the delivery, implement a self-cleaning cycle of the mixing head by closing the spool in the mixing chamber and the self-cleaning rod in the delivery duct, and to proceed with the replacement of the distributors. In particular, during the self-cleaning cycle of the mixing head chips of reacted resin are expelled which tend to clog the connected distributor and these residues can also begin to hinder the next new distributor so that the replacement of the distributors should take place after completion of the self-cleaning operations of the mixing heads.

The interruption of supply for the time necessary to replace the distributor and to clean the connections causes numerous problems and costs for the producers of continuous insulation panels.

The activities of cleaning the heads and changing the replaceable distributors waste production time and produce a long section of panel waste due to the fact that it is not possible to stop the conveyor when dispensing stops because otherwise the foam would flow over and out of the walls of the conveyor.

To avoid these problems in the known art it is preferred to use reserve mixing heads to give continuity with a very short interruption to the supply.

In the known art, there are three working mixing heads and an equal number of three mixing heads are ready on standby to take the place of the first three mixing heads when they need to be interrupted for cleaning.

The three heads in standby require to be deployed on a special extendable and retractable support structure above the lower substrate before reaching the conveyor in the pouring position. Moreover, they require to be connected to flexible pipes (usually eight (8) for each mixing head) and to electrical cables plus to the same number of valves for switching the flow rate deliveries as well as to the recirculation lines to and from the respective polymeric liquid dosing means. The installation and connection of the standby mixing heads to the control and supply systems are expensive and cumbersome.

Therefore, in the current technique, to remedy the problem of the accumulation of reacted resin in the delivery and distribution ducts in continuous foaming systems, two racks of mixing heads are installed with preferably three mixing heads each. One rack delivers the reactive resins and the other rack is on standby with the mixings heads ready to take the place of the ones currently operating.

To switch over from the clogged mixing heads on the fly to the standby mixing heads, it is necessary to close the flows of resins delivered to the clogged mixing heads and switch them over to the standby mixing heads, already positioned above the substrate conveyor and equipped with new distributors.

Once mixing in the first three mixing heads is terminated by closing the respective spools, mixing on the three replacement mixing heads has to be initiated: The flows of reactive resins are diverted to the new mixing heads, these mixing heads are controlled by the control system to dispense mixture and the flows of reactive polymeric mixture towards the substrate resumes after seconds. Meanwhile the previous mixing heads can be removed from their dispensing position above the poring position in order to replace the used replaceable dispensers, clean their couplings and install the new distributors.

The switching over between the sets of mixing heads requires for the three additional mixing heads the complete installation of their support system and the installation of the valves that switch the flows of the resins in and out of the mixing heads. It is so far necessary to duplicate the valves that distribute the resins (at least four (4) valves for each head), the flexible hoses that feed and recirculate the resins (at least four (4) for each head), the hydraulic oil hoses (at least four (4) hoses for each head), the oil control valves (at least two (2) valves for each head). In addition, it is necessary to install and power the pressure and temperature sensors and the two proximity switches for each mixing head.

### SUMMARY

It is an object of the present invention to provide a high pressure mixing head that is capable of performing cleaning operations and replacement of disposable ducts during a continuous production run with reduced interruption time, with reduced installation work and with less components for the mixing heads. In particular, it is an object of the present invention to provide a mixing head which allows cleaning operations and replacement of disposable duct during a continuous production run without need for a complete standby mixing head and without need for duplicating control units for standby mixing heads. Furthermore, it is an object of the present invention to provide a mixing head which allows to switch over from an output duct to an alternate or standby output duct within a very short time period, without need to switch over to a separate complete mixing head.

This object is achieved by the high pressure mixing head comprising the features of claim 1. Preferred embodiments of the invention are defined in the dependent claims.

The high pressure mixing head for continuously mixing and delivering reactive mixture producing polymeric foam comprises a body including a mixing chamber and injectors for injecting at least two polymeric liquids into the mixing chamber. A spool is disposed moveable in the mixing chamber in a longitudinal direction thereof between a retracted position in which the injectors are able to inject jets of polymeric liquids into the mixing chamber to be mixed under turbulent conditions so that a reactive polymeric mixture is expelled from an output opening of the mixing chamber, and an advanced position in which the spool is advanced in the mixing chamber beyond the injectors and the polymeric reactive liquids from the injectors are returned to be recycled via recirculation lines.

The high pressure mixing head further comprises a delivery duct having a longitudinal axis disposed transversely to the mixing chamber. A rod is slidably received in an internal passageway of the delivery duct and is connected to a piston of an actuator which is configured to move the rod along the longitudinal axis of the delivery duct between a retracted position in which the internal passageway along the delivery duct is in flow communication with the mixing chamber to receive the reactive polymeric mixture expelled from the output opening of the mixing chamber for conveying it along the internal passageway and into a distributor connected to an output end of the delivery duct for dispensing the polymeric reactive mixture to produce foam resulting from the reactive polymeric mixture, and an advanced position in which it is moved all along the internal passageway to clean it, wherein the rod is of complementary cross-sectional shape to the internal passageway of the delivery duct up to the position it is moved to. The wording that the rod is of complementary cross-sectional shape to the internal passageway is intended to mean that the rod is able to close the internal passageway for fluid flow, but on the other hand there is sufficient clearance for the rod so that it is able to slide with the internal passageway.

Furthermore, it is noted here that the term “transverse” as used herein is understood to mean “situated or lying across” and not necessarily “perpendicular” in a strict sense. The transverse arrangements may preferably include angles close or equal to 90°, but may for example deviate by up to 20° from a right-angled arrangement.

According to the present invention the high pressure mixing head is provided with an alternate delivery duct having the same features and functionality as the delivery duct, which alternate delivery duct therefore can take the place of the delivery duct when the latter needs cleaning in which case the alternate delivery duct takes over the task to convey polymeric mixture from the mixing chamber to a distributor for dispensing the polymeric reactive mixture to produce foam. The alternate delivery duct extends transversely to the delivery duct and to the mixing chamber. The delivery duct and the alternate delivery duct are in flow communication with the mixing chamber via a switchable flow connection. A control unit is configured to control the switching flow connection and the positions of the rods along the delivery ducts and the alternate delivery duct such that flow from the output opening of the mixing chamber can be selectively directed either to the delivery duct or to the alternate delivery duct. As noted, the alternate delivery duct has the same features and functionality as described above for the delivery duct, namely it extends transversely to the mixing chamber and comprises a rod of the alternate delivery duct slidably received in an internal passageway of the alternate delivery duct. A piston of an actuator for the rod of the alternate delivery duct is connected to the rod of the alternate delivery duct. The actuator of the rod of the alternate delivery duct is configured to move the rod of the alternate delivery duct along a longitudinal axis of the alternate delivery duct between (i) a retracted position in which the internal passageway of the alternate delivery duct is able to be in flow communication with the mixing chamber to receive reactive polymeric mixture for conveying the polymeric mixture along the internal passageway of the alternate delivery duct and into a distributor of the alternate delivery duct connected to an output end of the alternate delivery duct for dispensing polymeric foam resulting from reactive polymeric mixture, and (ii) an advanced position of the rod of the alternate delivery duct in which the rod of the alternate delivery duct is moved all along the internal passageway of the alternate delivery duct for cleaning the internal passageway of the alternate delivery duct. To be able to clean the internal passageway of the alternate delivery duct by expelling any residual materials therefrom the rod of the alternate delivery duct is of complementary cross-sectional shape to the internal passageway of the alternate delivery duct so that the rod of the alternate delivery duct closes the internal passageway of the alternate delivery duct up to the position the rod of the alternate delivery duct is moved to. In this way the alternate delivery duct is configured, in the same way as the delivery duct, to receive polymeric mixture from the mixing chamber for conveying the polymeric mixture to the distributor for dispensing polymeric foam resulting from the polymeric mixture.

In this manner it is possible, when, during a continuous production run, a cleaning operation of the delivery duct and/or a cleaning operation and a replacement of disposable distributors is necessary, to switch over from the delivery duct to the alternate delivery duct as immediate change (replacement) of the active output component, within a very short period of time (within seconds) and without any installation work for the switchover. The switchable flow connection and the positioning of the rods in the delivery duct and the alternate delivery duct in cooperation form a turnout or switch in the flow path from the mixing chamber, wherein this switch is controlled by the control unit to direct the output flow from the mixing chamber either to the delivery duct or to the alternate delivery duct, thereby allowing to switch over from the delivery duct to the alternate delivery duct, when cleaning and replacement of the distributor is required for the delivery duct, or vice versa from the alternate delivery duct to the delivery duct. In this connection no changes are required for the mixing chamber and its control, after switching over from the delivery duct to the alternate delivery duct as active output component, or vice versa, while the operation of the mixing chamber continues as before or, at most with a very short period of interruption of less than two (2) seconds when its cleaning is necessary.

It has to be appreciated that, in comparison to the conventional use of two complete separate mixing heads, the high pressure mixing head according to the present invention allows to switch over to the alternate or standby delivery duct as active output component much faster because no installation work or other arrangements regarding the control unit are needed to guarantee a smooth transition between the delivery duct and the alternate delivery duct, with continued operation of the mixing chamber or, at most, with a very short period of interruption of less than two (2) seconds when its cleaning is necessary.

It should be specifically noted that the high pressure mixing head according to the present invention is a much simpler solution and needs less components because the mixing chamber and its associated components is not duplicated as in the prior art where two separate mixing heads and two mixing chambers with their associated components and supply and recirculation lines were necessary. It also will be appreciated that the high pressure mixing heads according to the present invention permit that continuous production runs over extended periods of time can be performed with greatly improved efficiency because the time for switching over to an alternate delivery duct is drastically reduced and no installation work is needed in connection with the switchover.

In a preferred embodiment the switchable flow connection is formed by an enlarged diameter end portion of the internal passageway of the delivery duct and by a sleeve slidably received therein. The enlarged diameter end portion extends from the end of the delivery duct opposite to its output end and extends along the internal passageway beyond the output opening of the mixing chamber such that the enlarged diameter end portion is in flow communication with the output opening of the mixing chamber. The sleeve received in the enlarged end portion has an internal diameter equal and fitting to the internal diameter of the remaining internal passageway of the delivery duct, wherein equal and fitting to is not meaning equal to in a strict mathematical sense, but to include tolerances of +/−1/350 of the diameter and a small clearance as required for the sleeve to be slidable. The sleeve is slidably moveable within the enlarged diameter end portion between a closing position in which it covers the output opening of the mixing chamber and a retracted position in which it leaves open at least part of the output opening of the mixing chamber to allow flow from the mixing chamber into the enlarged diameter end portion. The longitudinal axes of the delivery duct and of the alternate delivery duct do not extend in a common plane, but are shifted, in a direction perpendicular to the longitudinal axes of the delivery duct and the alternate delivery duct, with respect to each other to such extent that the enlarged diameter end portion of the delivery duct and the internal passageway of the alternate delivery duct intersect (in other words, the volumes of the enlarged diameter end portion of the delivery duct and of the internal passageway of the alternate delivery duct have an overlapping portion), thereby forming a delivery duct opening for a flow communication between the enlarged diameter end portion of the delivery duct and the internal passageway of the alternate delivery duct, such that, when the control unit controls the position of the sleeve to be in the retracted position, output from the mixing chamber is directed to the delivery duct by positioning the rod of the delivery duct to open its internal passageway and by positioning the rod of the alternate delivery duct to close its internal passageway, whereas output from the mixing chamber is directed to the alternate delivery duct by positioning the rod of the alternate delivery duct to open its internal passageway and by positioning the rod of the delivery duct to close its internal passageway. In this manner a simple and efficient switchover operation can be performed by positioning the rods of delivery duct and the alternate delivery duct accordingly. Furthermore, in this embodiment the movable sleeve received in the enlarged diameter end portion of the delivery duct forms a cleaning member which, by moving to the closing position, also cleans the enlarged diameter end portion. In this case of the longitudinal axes of the delivery duct and the alternate delivery duct not being in the same plane, the angle between the longitudinal axes is defined by projecting the longitudinal axes onto a plane that extends through the midpoint of the shortest line connecting the longitudinal axes and is perpendicular to this line.

In a preferred embodiment the delivery duct opening is located, in flow direction through the delivery duct, downstream of the output opening of the mixing chamber. Although an upstream location of the delivery duct opening would be a possible, the downstream location is preferred because in case of an upstream location the rod of the delivery duct would have to be retracted even further so that its front face is upstream of the delivery duct opening.

In a preferred embodiment the sleeve has an inclined inner end face (inclined with respect to a plane that is perpendicular to the longitudinal axis of the delivery duct), and a longitudinal inner end region of the enlarged diameter end portion is provided with an oppositely inclined end face facing the inclined end face of the sleeve such that, when the sleeve is moved to the closing position, its inclined end face is in abutment on the oppositely inclined end face of the inner end region, and such that, when the sleeve is moved to its retracted open position, an inclined gap is formed between the end face of the sleeve and the end face of the inner end region. This inclined gap forms, when the rod of the delivery duct is closing its internal passageway, an inclined annular flow path from the output opening of the mixing chamber, around the circumference of the rod of the delivery duct to the delivery duct opening and into the alternate delivery duct. Such annular flow path from the output opening of the mixing chamber to the internal passageway of the alternate delivery duct enhances mixing while it calms down any turbulences.

In a preferred embodiment the retracted position of the rod of the delivery duct is adjustable to a partial closing position in which its front end face is located downstream of the output opening of the mixing chamber and is located within the inner end region of the enlarged diameter end portion. This adjusted positioning is referred to as partial closing position because it is partially closing the output opening of the mixing chamber because the rod extends to a downstream position with respect to the output opening of the mixing chamber, but leaves open, when the sleeve is in the retracted open position, when the rod of the delivery duct is in the partial closing position and when the rod of the alternate delivery duct is in its advanced position closing its internal passageway, a flow path for fluid flow from the output opening of the mixing chamber through the inclined gap around the rod of the delivery duct and into the section of the inner end region of the enlarged diameter end portion and from there continues into the adjoining internal passageway of the delivery duct towards its output end. In this embodiment the fluid flow from the output opening of the mixing chamber is not directly into the internal passageway of the delivery duct but via an intermediate flow path through the annular inclined gap and around the peripheral surface of the rod of the delivery duct.

In an alternative embodiment the sleeve has characterized in that the sleeve has a frustro-conical end face that can be either outwardly inclined (i.e. the frusto-conical section extends axially beyond the cylindrical section of the sleeve as in FIG. 8) or inwardly inclined (i.e. the frusto-conical section extends axially into the cylindrical section of the sleeve and is formed in the interior of the sleeve as in FIG. 12), such that between the frustro-conical end face and an annular complementary frustro-conical shoulder terminating the enlarged diameter end portion of the internal passageway of the delivery duct an annular gap is formed, which annular gap forms, when the rod of the delivery duct is closing its internal passageway, an annular flow path around the rod of the delivery duct from the output opening of the mixing chamber to the delivery duct opening and into the alternate delivery duct; alternatively the sleeve has a flat end face (as in FIG. 11) such that between the flat end face and an complementary flat annular shoulder terminating the enlarged diameter end portion of the internal passageway of the delivery duct an annular gap is formed, which annular gap forms, when the rod of the delivery duct is closing its internal passageway, an annular flow path around the rod of the delivery duct from the output opening of the mixing chamber to the delivery duct opening and into the alternate delivery duct.

In this embodiment there are no inclined surfaces (inclined with respect to a plane that is perpendicular to the longitudinal axis of the delivery duct), neither on the end face of the sleeve nor in an inner end region of the enlarged diameter end portion.

In a preferred embodiment the inner end face of the sleeve is provided with a recess of complementary shape to a portion of the surface of the rod of the alternate delivery duct projecting through the delivery duct opening into the enlarged diameter end portion of the internal passageway of the delivery duct. When the rod is closing the alternate delivery duct, due to this configuration, the movement of the sleeve to its closing position is not obstructed since the projecting portion of the rod of the alternate delivery duct is received in the recess of the inner end face of the sleeve when it reaches its closing position.

In a preferred embodiment the sleeve is connected to a pneumatic or hydraulic actuation cylinder for selectively moving the sleeve between the retracted position and the closing position under the control of the control unit, wherein the sleeve, when it is moved from the retracted open position to the closing position, acts as a cleaning member for the enlarged diameter end portion of the internal passageway of the delivery duct, expelling the resin inside the annular gap into the delivery duct or the alternate delivery duct depending on which one of these is open.

In an alternative preferred embodiment, the switchable flow connection of the high pressure mixing head is realized in the following manner. The delivery duct and the alternate delivery duct are extending with their longitudinal axes in the same plane such that the internal passages of the delivery duct and the alternate delivery duct are crossing each other in a crossing zone. The longitudinal axis of the mixing chamber is inclined by less than 20° with respect to a normal to the plane of the delivery duct and the alternate delivery duct such that the output opening of the mixing chamber is merging into the crossing zone of the internal passageways of the delivery duct and the alternate delivery duct, wherein the output opening of the mixing chamber is not centered with respect to the intersection point of the longitudinal axes of the delivery duct and the alternate delivery duct, but is displaced along the bisecting line of the between the delivery duct and the alternate delivery duct towards the output ends of the delivery duct and the alternate delivery duct, thereby forming the switchable flow connection such that the switchable flow connection directs output flow from the mixing chamber around the rod of the alternate delivery duct into the internal passageway of the delivery duct beyond the crossing zone when the rod of the alternate delivery duct is positioned to extend beyond the crossing zone and the rod of the delivery duct is positioned to extend up to the rod of the alternate delivery duct, and such that the switchable flow connection directs output flow from the chamber around the rod of the delivery duct into the internal passageway of the alternate delivery duct beyond the crossing zone when the rod of the delivery duct is positioned to extend beyond the crossing zone and the rod of the alternate delivery duct is positioned to extend up to the rod of the delivery duct.

In a preferred embodiment the longitudinal axis of the mixing chamber is extending in a plane that is perpendicular to the plane of the delivery duct and the alternate delivery and that includes the bisecting line between delivery duct and the alternate delivery duct.

In a preferred embodiment the delivery duct and the alternate delivery duct are extending with their longitudinal axes in the same plane with their longitudinal axes forming an angle of 90°+20° with each other.

In a preferred embodiment the displacement of the output opening of the mixing chamber with respect to the intersection point of the longitudinal axes of the delivery duct and the alternate delivery duct and the diameters of the output opening of the mixing chamber and of the internal passageways of the delivery duct and the alternate delivery duct are such that, when the rod in the delivery duct extends through the crossing zone, a segment of the cylinder-cylinder intersection forming the crossing zone of the internal passageways is open for the output opening of the mixing chamber and communicating with the internal passageway section of the alternate delivery duct beyond the crossing zone, and such that, when the rod in the alternate delivery duct extends through the crossing zone, a segment of the cylinder-cylinder intersection is open for the output opening of the mixing chamber and communicating with the internal passageway section of the delivery duct beyond the crossing zone. The output opening of the mixing chamber is displaced with respect to the intersection point of the longitudinal axes of the internal passageways of the delivery duct and the alternate delivery duct such that there is an overlap of a segment of the output opening with a segment of the cylinder-cylinder intersection forming the crossing zone of the internal passageways for the internal passageways of each of the delivery duct and the alternate delivery duct. The output opening of the mixing chamber merges with the overlapping portions into the cylinder-cylinder intersection of the internal passageways of the crossing zone so that, when one of the rods extends through the crossing zone, output flow from the mixing chamber can flow through the overlapping portion into the internal passageway of the other one of the delivery duct and the alternate delivery duct.

In a further alternative embodiment the switchable flow connection is formed in the following manner. In this embodiment the delivery duct and the alternate delivery duct are also extending with their longitudinal axes in the same plane. The crossing zone of the internal passageways of the delivery duct and the alternate delivery duct is intersected by a cylindrical cavity extending with its cylinder axis perpendicular to the plane formed by the longitudinal axes of the delivery duct and the alternate delivery duct, wherein the cylinder axis of the cylindrical flow diverter is intersecting the intersection point of the longitudinal axes of the delivery duct and the alternate delivery duct. The cylindrical flow diverter is, as part of the switchable flow connection, located in the cylindrical cavity with its cylinder axis coaxial with the cylinder axis of the cylindrical cavity, wherein the cylindrical flow diverter is rotatable about its cylinder axis and is with its cylinder axis aligned with the longitudinal axis of the mixing chamber. The flow diverter further comprises a throughgoing transverse opening forming a continuation of the internal passageway of the delivery duct and the alternate delivery duct, respectively, when the flow diverter is, under control of the control unit, rotated so that its throughgoing transverse opening is aligned with the internal passageway of the delivery duct and the alternate delivery duct, respectively. The cylindrical flow diverter further comprises an input opening which is in communication with the output opening of the mixing chamber and which communicates with the throughgoing transverse opening of the cylindrical flow diverter, such that, when the rods of the delivery duct and the alternate delivery duct are retracted to keep the throughgoing transverse opening open for fluid flow from the input opening to the throughgoing transverse opening, the switchable flow connection is delivering output flow from the mixing chamber to the delivery duct when the cylindrical flow diverter is directed to be, with its throughgoing transverse opening, aligned with the internal passageway of the delivery duct, and such that the switchable flow connection is delivering output flow from the mixing chamber to the alternate delivery duct when the cylindrical flow diverter is rotated to be, with its throughgoing transverse opening, aligned with the internal passageway of the alternate delivery duct.

In a preferred embodiment the throughgoing transverse opening of the flow diverter has an inner diameter equal to the inner diameter of the internal passageways of the delivery duct and the alternate delivery duct such that, when the throughgoing transverse opening is aligned with the internal passageway of the delivery duct and the alternate delivery duct, respectively, the rod of delivery duct and the alternate delivery duct, respectively, can be advanced under the control of the control unit to move through the throughgoing transverse opening and the remaining part of the internal passageway of the delivery duct and of the alternate delivery duct, respectively, to expel reactive polymeric mixture and residuals for cleaning purposes from the internal passageway. The control unit is configured to, after completing such cleaning operation, to retract the respective rod from the throughgoing transverse opening of the cylindrical flow diverter again to allow rotation of the flow diverter to the next alignment position with the internal passageway of the delivery duct or the alternate delivery duct.

In a preferred embodiment the cylindrical cavity has a cross-sectional shape complementary to the cross-section of the cylindrical flow diverter.

In a further aspect a method is provided for continuously producing polymeric foam using a high pressure mixing head according to the present invention, characterized in that during a first phase of a continuous production run the switchable flow connection of the high pressure mixing head is set to direct polymeric mixture expelled from the mixing chamber through the delivery duct for dispensing the polymeric foam resulting from reactive polymeric mixture through the distributor onto a moving substrate below the distributor, in that for terminating the first phase and for initiating a second phase of the continuous production run the switchable flow connection and the positions of the rods in the delivery duct and the alternate delivery duct are switched over such that flow from the output opening of the mixing chamber is directed to the alternate delivery duct to thereby immediately switch over to the alternate delivery duct as active output component for dispensing the polymeric foam through the through distributor of the alternate delivery duct onto the moving substrate for continuing the continuous production run in its second phase, and in that during the second phase of the production run the delivery duct is cleaned and its distributor is cleaned or replaced.

In a further aspect a polymeric foam production system utilizing a plurality of high pressure mixing heads according to the present invention is provided which comprises the features of claim 17. Preferred embodiments of the system are set out in claims 18-20.

### BRIEF DESCRIPTION OF THE DRAWING FIGURES

The present invention will now be described with reference to embodiments illustrated in the drawings in which:

FIGS. 1a) and b) are schematical perspective views of interior components of a first embodiment of a mixing head to illustrate its operation principle;

FIG. 2 is a perspective external view of the mixing head of the first embodiment;

FIG. 3 is a partial cross-sectional view of the mixing head of the first embodiment, wherein a switchable flow connection is in a state that directs output flow from the mixing chamber to the internal passageway of the delivery duct and wherein the alternate delivery duct in a closed state;

FIG. 4 is a cross-sectional view of the mixing head of FIG. 3, wherein the switchable flow connection is in the state that directs fluid flow from the output opening of the mixing chamber into the internal passageway of the delivery duct;

FIG. 5 is a cross-sectional view of the mixing head of the previous Figures, wherein the switchable flow connection is in an alternative state that directs output flow from the output opening of the mixing chamber into the internal passageway of the delivery duct;

FIG. 6 is a cross-sectional view of the mixing head of the first embodiment as in the previous Figures, wherein the switchable flow connection is in a state in which out flow from the output opening of the mixing chamber is directed to the internal passageway of the alternate delivery duct;

FIG. 7 is a cross-sectional view of alternate delivery duct with the rod in the retracted position so that output flow from the mixing chamber can be directed by the switchable flow connection to the internal passageway of the alternate delivery duct;

FIGS. 8 a) and b) are schematical perspective views of internal components of the mixing head according to a second embodiment to illustrate its operation principle;

FIG. 9 is a cross-sectional view of the mixing head of the second embodiment, wherein the switchable flow connection is in a state that directs fluid flow from the output opening of the mixing chamber into the internal passageway of the alternate delivery duct;

FIG. 10 is a cross-sectional view of the mixing head of FIG. 9, wherein the switchable flow connection is in a completely closed state preventing fluid flow from the output opening of the mixing chamber to any of the delivery duct and alternate delivery duct;

FIG. 11 is a cross-sectional view of a modified version of the second embodiment, wherein the switchable flow connection is in the state that directs output flow from the output opening of the mixing chamber into the internal passageway of the alternate delivery duct;

FIG. 12 is a cross-sectional view of a further modified version of the second embodiment, wherein the switchable flow connection in the state that directs output flow from the output opening of the mixing chamber into the internal passageway of the alternate delivery duct;

FIGS. 13 a) and b) are schematical perspective views of internal components of the mixing head according to a third embodiment to illustrate its operation principle, and FIG. 13 c) is a perspective view of the spool of the mixing head according to the third embodiment to illustrate the shape of the mixing head facing end of the spool adapted to the shape of the crossing zone;

FIG. 14 is a cross-sectional view of the mixing head of the third embodiment taken in the plane of the internal passageways of the delivery duct and the alternate delivery duct, wherein the switchable flow connection is in the state that directs output flow from the output opening of the mixing chamber into the internal passageway of the delivery duct, together with an enlarged detail of a crossing zone of the internal passageways;

FIG. 15 is a cross-sectional view of the mixing head of FIG. 14, wherein the switchable flow connection is in a state that directs fluid flow from the output opening of the mixing chamber into the internal passageway of the alternate delivery duct together with an enlarged detail of a crossing zone of the internal passageways;

FIG. 16 a) and b) are schematical perspective views of internal components of the mixing head according to a fourth embodiment to illustrate its operation principle;

FIGS. 17 a) and b) are further schematical perspective views as in FIGS. 16 a) and b) in a different state of the switchable flow connection of the fourth embodiment;

FIG. 18 is a cross-sectional view of the mixing head of the fourth embodiment, wherein the cross-sectional view shows the mixing chamber and the delivery duct in cross-section, wherein the switchable flow connection is in a state that directs output flow from the output opening of the mixing chamber into the internal passageway of the delivery duct;

FIG. 19 is a cross-sectional view of the mixing head of FIG. 18, wherein the cross-section is taken in the common plane of the delivery duct and the alternate delivery duct and wherein the switchable flow connection is in the state directing fluid flow from the output opening of the mixing chamber into the internal passageway of the delivery duct;

FIG. 20 is a perspective external view of the mixing head;

FIGS. 21a and 21b show a perspective views of a multiple mixing head assembly, wherein in FIG. 21b one of the two subassemblies of distributors is detached from its associated delivery ducts and in transverse direction moved out of the area above the conveyor;

FIG. 22 is a side view, partially in cross-section, of the multiple mixing head assembly of 21a and 21b; and

FIG. 23 is a cross-sectional view of a connection area of a delivery duct and its associated distributor.

### DETAILED DESCRIPTION

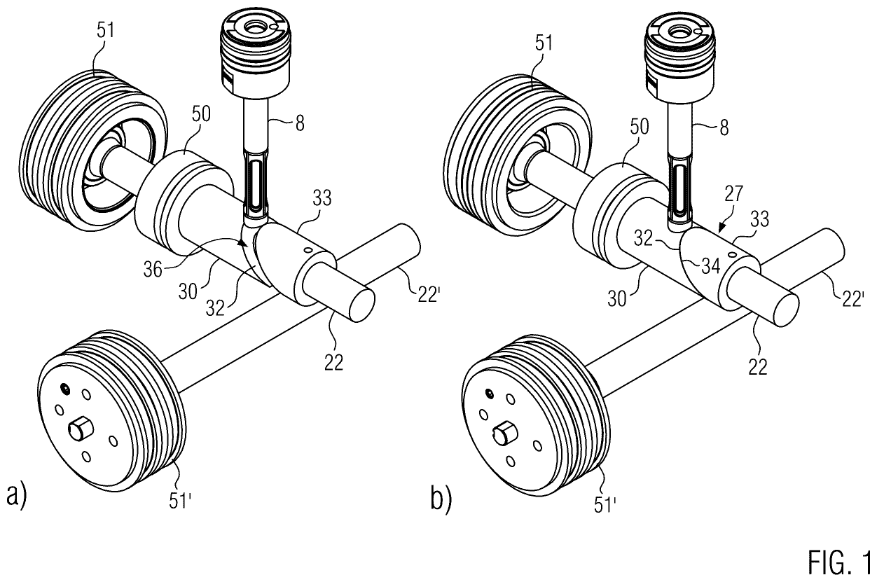

FIGS. 1a) and b) show perspective views of internal components of a first embodiment of the mixing head in a very schematical manner to allow an easier understanding of the working principle of the high pressure mixing head. The mixing head comprises a mixing chamber, a delivery duct and an alternate delivery duct. In the mixing chamber a spool 8 is slidably received, and in the delivery duct a rod 22 is received which is attached to a piston which allows to move the rod 22 to a retracted position in which it is retracted beyond the mixing chamber such that the section of the internal passageway of the delivery duct downstream of the mixing chamber is open, and an advanced position in which the rod 22 extends all along the internal passageway of the delivery duct to its output end.

In the internal passageway of the alternate delivery duct a corresponding rod 22′ is slidably received and likewise connected to a piston which allows to move it between the retracted and the advanced position in the same way as the rod 22 of delivery duct.

In FIGS. 1a) and b) the mixing chamber, the delivery duct and the alternate delivery duct are not shown but only the spool 8, and the rods 22, 22′ which are slidably disposed therein. In FIGS. 1 a) and b) both rods 22, 22′ are shown in an advanced position to illustrate the extension of the internal passageways of the delivery duct and the alternate delivery duct. Likewise, the spool 8 is shown in the advanced position in which the front end face of the spool 8 is located in the output opening of the mixing chamber to illustrate where the output opening of the mixing chamber is located in this schematical illustration of the mixing head.

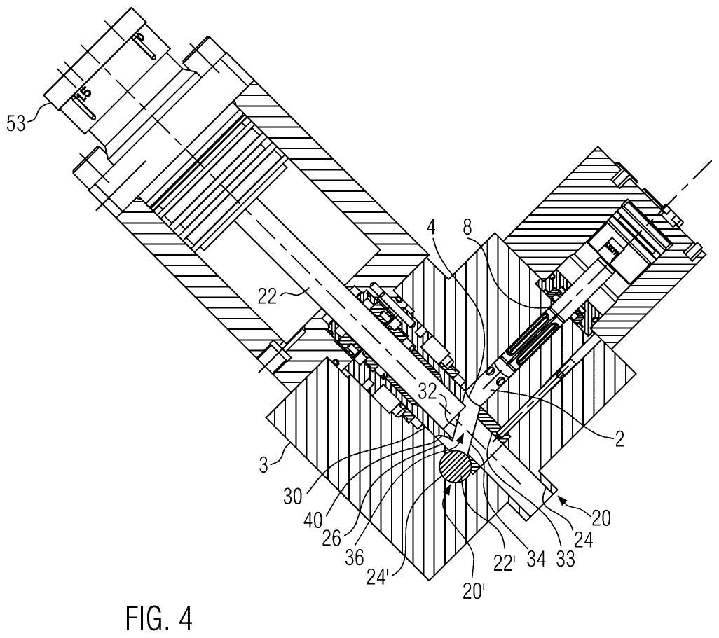

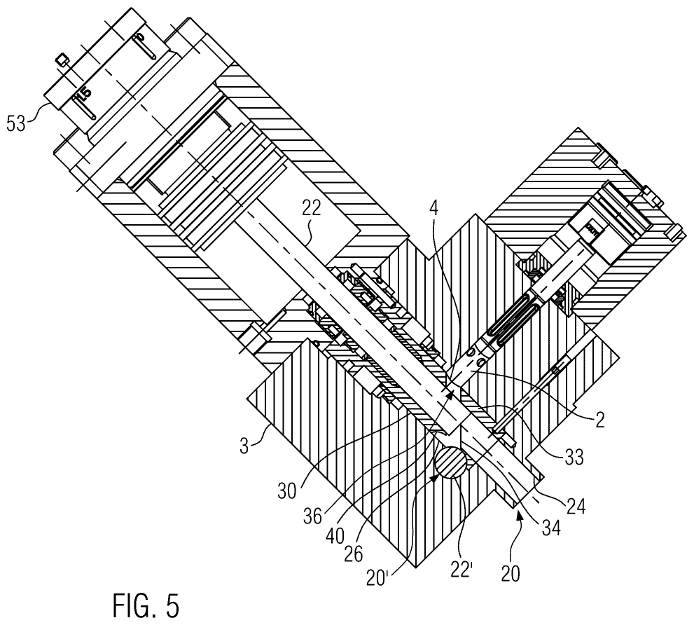

In an enlarged diameter end portion of the internal passageway of the delivery duct which is located opposite to the output end of the delivery duct a sleeve 30 is slidably received. Opposite to the slidable sleeve 30 a fixed sleeve end section 33 is disposed. The sleeve 30 has an inclined inner end face 32, and the fixed sleeve section 33 has an oppositely inclined end face 34. In the illustrated embodiment the fixed sleeve section 33 is shown as a separate member that is inserted into the enlarged diameter end portion 26 (see FIGS. 4, 5) and fixed therein. However, instead of fixing a separate sleeve section 33 in the end section of the enlarged diameter end portion, this end section could also be formed by machining the enlarged diameter end portion 26 into the mix head body 3 so that this end section would be part of the body 3, instead of being a separate member 33 as in the illustrated embodiment.

The sleeve 30 is coupled to a piston which can move it between an open position in FIG. 1 a) and an advanced closed position in FIG. 1 b) in which the sleeve 30 covers the output opening of the mixing chamber. Accordingly, the output opening the mixing chamber is in the state of FIG. 1 a) open towards an inclined gap 36 between the sleeve 30 and the fixed sleeve section 33. In this state output flow from the output opening of the mixing chamber can flow into the inclined gap 36 and, depending on the positioning of the rods 22, 22′, from there either into the internal passageway of the delivery duct (surrounding rod 22) or in the internal passageway of the alternate delivery duct (surrounding the rod 22′).

In the state of FIG. 1 b) the output opening of the mixing chamber is closed by the sleeve 30 so that there is no output flow from the mixing chamber and the mixing head is in a closed state.

In the state of FIG. 1 a) output flow from the mixing chamber could, if the spool 8 would be in its retracted position to open the mixing chamber, flow into the inclined gap 36 between the sleeve 30 and the fixed sleeve end sections 33, wherein the moveable sleeve 30 forms part of the switchable flow connection. If in the state of FIG. 1 a) (with spool 8 retracted) output flow from the mixing chamber flows into the inclined gap 36, the positioning of the rods 22, 22′ determines whether the output flow from the mixing chamber is directed into the internal passageway of the delivery duct or of the alternate delivery duct.

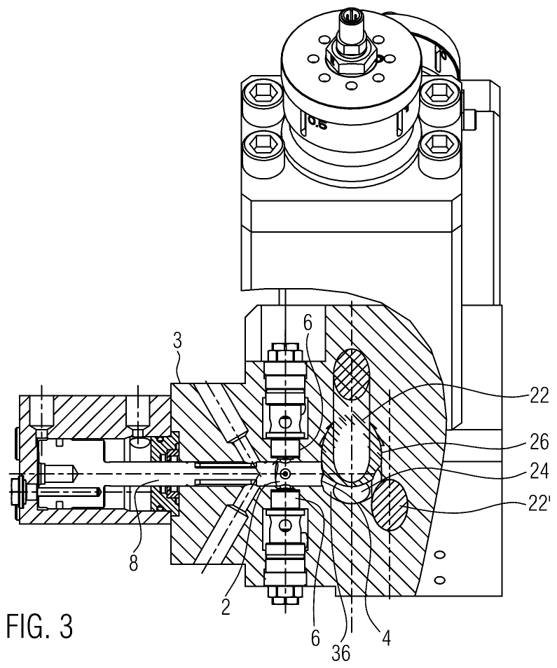

If in the state of FIG. 1 a) the rod 22 of the delivery duct is retracted such that its front end face is in the axial region of the internal passageway of the delivery duct in which the inclined gap 36 is located (as shown in FIG. 3), and the rod 22′ of the alternate delivery duct is in the advanced position as shown, output flow from the mixing chamber flows through the internal gap 36 and from there into the internal passageway of the delivery duct beyond the front end face of the rod 22.

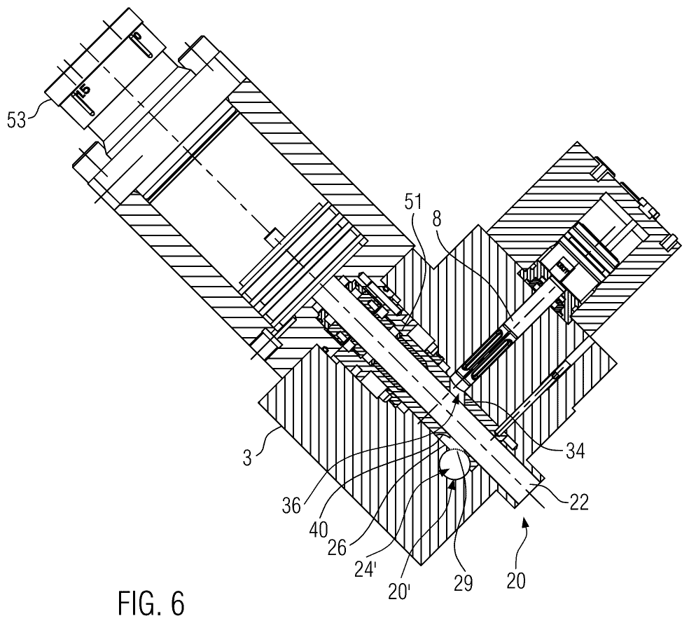

If in the state of FIG. 1 a) (again with the spool 8 being retracted to open the mixing chamber) the rod 22 is in an advanced position as shown in FIG. 1 a) and the rod 22′ is, from the advanced position shown in FIG. 1 a) retracted, like in FIG. 6, output flow from the mixing chamber enters the inclined gap 36, flows around the circumferential surface of the advanced rod 22 and from the inclined gap 36 through a delivery duct opening, which forms an opening connecting the enlarged diameter end portion of the internal passageway of the delivery duct and the internal passageway of the alternate delivery duct, into the internal passageway of the alternate delivery duct, thereby directing the output flow from the inclined gap 36 to the internal passageway of the alternate delivery duct.

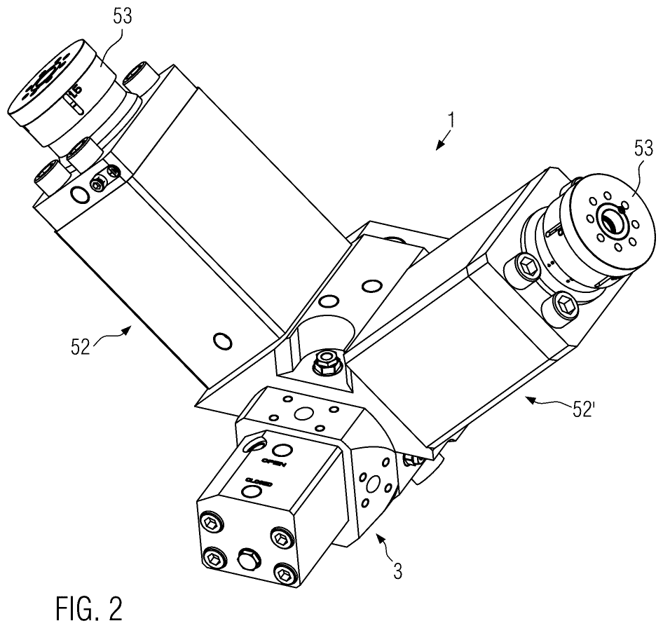

FIG. 2 shows a perspective external view of the mixing head 1 showing the perpendicular housing components of the delivery duct 20, the alternate delivery duct 20′ and the mixing head body 3 housing the mixing chamber 2.

The switching operation of the switchable flow connection will be described in more detail below with reference to FIGS. 3 to 7.

In the cross-sectional views of FIGS. 3 and 4 the mixing spool 8 is open and the switchable flow connection is in a state in which output flow from the mixing chamber 2 is directed to the internal passageway 24 of the delivery duct 20, whereas the internal passageway 24′ of the alternate delivery duct 20′ is closed. In the cross-sectional view of FIG. 4 the sleeve 30 is, as in FIG. 1a), in the retracted open position and the spool 8 is in the retracted position so that the injected polymeric liquids are mixed in the mixing chamber 2, and the mixture is expelled through the output opening 4 of the mixing chamber and flows into the inclined gap 36. Since the rod 22 is retracted in the continuation of the internal passageway 24 formed within the sleeve 30, and the rod 22′ within the internal passageway of the alternate delivery duct 20′ is in the advanced position closing the internal passageway of the alternate delivery duct 20′, output flow from the mixing chamber 2 flows in front of the front end face of rod 22 into the inclined gap 36 and from there further into the internal passageway 24 of the delivery duct 20 towards its output end. This situation is also illustrated FIG. 3 which is a partial cross-sectional view and a partial perspective view. The mixing chamber 2 is in the open condition with spool 8 retracted so that the polymeric liquids ejected by the injectors 6 are mixed in the mixing chamber 2 and are expelled through the output opening 4 of the mixing chamber 2 into the enlarged diameter end portion 26 of the internal passageway 24 of the delivery duct, namely into the inclined gap 36 described before in connection with FIG. 4. In FIG. 3 the output opening 4 is shown to communicate with the enlarged diameter end portion 26, and in a perspective manner also the internal passageway 24 of the delivery duct is visible inside the enlarged diameter end portion 26. The rod 22 is sufficiently retracted in the sleeve 30 so that the output flow through the output opening 4 of the mixing chamber 2 can flow into the enlarged diameter end portion 26 (in the area of the inclined gap 36 of FIG. 4) and from there further into the internal passageway 24 of the delivery duct, because rod 22 is sufficiently retracted in the sleeve 30, whereas the internal passageway of the alternate delivery duct is shown closed by the rod 22′ in FIG. 3.

FIG. 5 shows an alternative state of the switchable flow connection in which output flow from the mixing chamber 2 is directed into the internal passageway 24 of the delivery duct. The adjusted state of the rod 22 in FIG. 5 differs from the state in FIG. 4 in that the rod 22 is slightly further advanced and is disposed with its front end face axially, by means of a stroke adjuster 53, in a position that is within the axial range covered the oppositely inclined end face 34 of the fixed sleeve section 33 so that the internal passageway 24 continued within interior of the fixed sleeve section 33 is partly open and not completely closed by the rod 22. In this state output flow from the mixing chamber 2 enters the inclined gap 36 and, because of the advanced positioning of the front end face of the rod 22 within the inclined gap 36, has first to flow around the circumferential surface of the rod 22 in the internal gap 36, before the fluid flow enters the internal passageway 24 of the delivery duct 20 through the fixed sleeve section 33. At the same time the rod 22′ is in the advanced position in the internal passageway of alternate duct 20′ so that the alternate delivery duct 20′ is closed. Compared to the situation of FIG. 4, the output flow from the mixing chamber has to take a detour to flow through an annular channel within the inclined gap 36 around the circumferential surface of the rod 22, before reaching the internal passageway 24 of the delivery duct, wherein this flow diversion is advantageous because it calms downs the flow of the polymeric mixture that is expelled under high pressure through the output opening 4 of the mixing chamber 2.

The cross-sectional view of FIG. 6 shows the state in which the switchable flow connection and the rods 22, 22′ are adjusted such that output flow from the mixing chamber (if the spool 8 would be retracted to open the mixing chamber) is directed into the internal passageway 24′ of the alternate delivery duct 20′. As can be seen in FIG. 6 the piston connected to the rod 22 is advanced such that the rod 22 extends along the internal passageway of the delivery duct 20, thereby closing it. On the other hand, the rod of the alternate delivery duct 20′ is sufficiently retracted so that the internal passageway 24′ is visible in the cross-sectional view of FIG. 6 as an open circle. As can be seen in this cross-sectional view, the internal passageway of the delivery duct 20 and of the alternate delivery duct 20′ are not extending with their longitudinal axes in the same plane, but the longitudinal axes of the delivery duct 20 and the alternate delivery duct 20′ are shifted to such extent that the internal passageways themselves do not intersect, whereas the internal passageway 24′ of the alternate delivery duct 20′ intersects with the enlarged diameter end portion 26 of the delivery duct 20. This means that the internal passageway 24′ of the alternate delivery duct 20′ is in the plane of the cross-section shown in FIG. 6 open towards the enlarged diameter end portion 26 of the internal passageway of the delivery duct 20, namely in a region of a delivery duct opening 29 which is indicated in FIG. 6 by a dotted circle segment. In fact, the dotted circle segment in the region of the delivery duct opening 29 is open in the plane of cross-section of FIG. 6 so that fluid flow from the enlarged diameter end portion 26 into the internal passageway 24′ of the alternate delivery duct 20′ is possible, wherein the circle segment shown as dotted line is an indication of the output end opening of the internal passageway 24′ at the output end of the alternate delivery duct 20′ which is spaced apart from the plane of the cross-section of FIG. 6. Therefore, output flow from the mixing chamber flows through the inclined gap 36, in an annular channel around the circumferential surface of the rod 22 to the enlarged diameter end portion 26 in front of the inclined end face of the sleeve 30, and from there through the delivery duct opening 29 into the internal passageway 24′ of the alternate delivery duct.

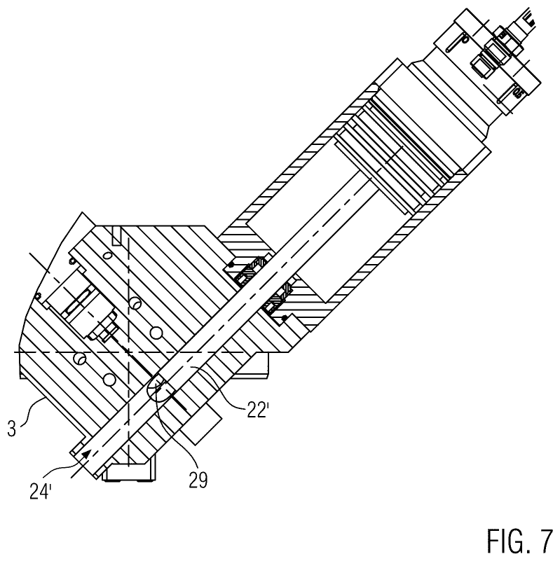

The same state of the switchable flow connection and of the positioning of the rods 22, 22′ as in FIG. 6 is shown in the cross-section of FIG. 7, wherein the cross-sectional view of FIG. 7 is taken in the plane in which the longitudinal axis of the internal passageway 24′ of the alternate delivery duct is extending. Accordingly, rod 22′ of the alternate delivery duct is shown in the retracted position and keeps clear the delivery duct opening 29 towards the enlarged diameter end portion 26 of the internal passageway 24 of the delivery duct so that output flow from the mixing chamber flows through the inclined gap 36 (see FIG. 6), through the annular channel around the circumferential surface of the rod 22 in the delivery duct 20, and eventually flows through the enlarged diameter end portion 26 in front of the sleeve 30 through the delivery duct opening 29 into the internal passageway 24′ of the alternate delivery duct.

As can be seen in the cross-sectional views of FIGS. 4-6 the sleeve 30 is provided with a recess 40 in its front end surface in the region of the intersection with the internal passageway of the alternate delivery duct 20′, wherein the recess 40 is of complementary shape to the portion of the rod 22′ which, when the rod 22′ is advanced to extend through the intersection zone with the enlarged diameter end portion 26 of the delivery duct 20, projects into the enlarged diameter end portion 26. The recess 40 allows that the sleeve 30 can be advanced to its closing position closing the mixing chamber and the internal gap 36, without interfering with the rod 22′.

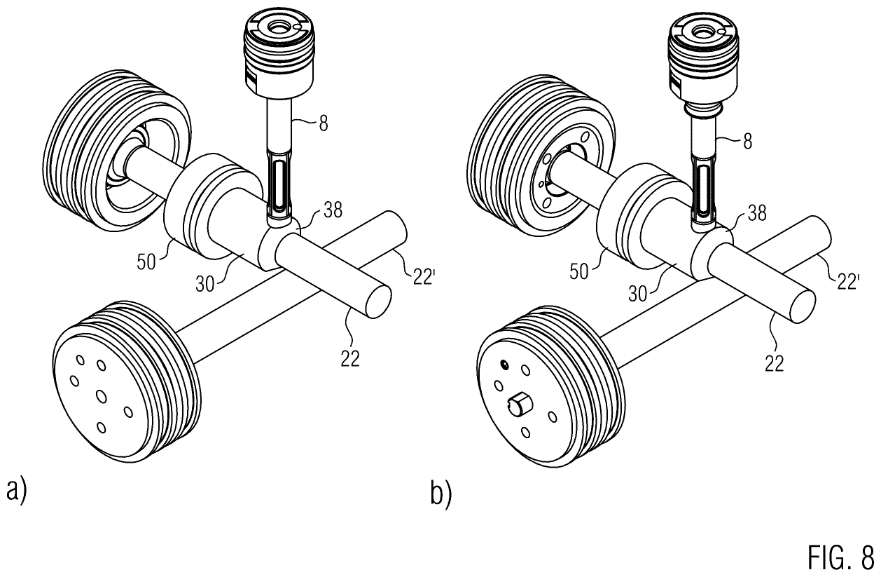

FIGS. 8 a) and b) show schematical perspective views of a second embodiment of a mixing head with a switchable flow connection. The configuration of the mixing chamber, the delivery duct and the alternate delivery duct is the same as in the first embodiment of FIGS. 1 a) and b). In particular, the configuration of the internal passageway of the alternate delivery duct and the enlarged diameter end portion of the internal passageway of the delivery duct is the same as in the embodiment of FIGS. 1 a) and b): They are intersecting and thereby form a delivery duct opening connecting the internal passageway of the alternate delivery duct with the enlarged diameter end portion of the delivery duct. The second embodiment of FIGS. 8 a) and b) differs from the first embodiment in the shape of the front end face of the sleeve 30 which is not inclined, but has an annular frusto-conical end face 38. Furthermore, there is no opposing fixed sleeve section, but the end of the enlarged diameter end portion 26 of the internal passageway of the delivery duct is formed into the mixing head body 3 by an inwardly projecting shoulder extending circumferentially from the inner wall of the enlarged diameter end portion 26 to the inner wall of the internal passageway 24 of the delivery duct.

As in the first embodiment, the sleeve 30 is connected to a piston 50 of an actuator configured to move the sleeve 30 between a closing position in which it covers the output opening of the mixing chamber (FIG. 8 b)) and in which the front end face of the spool 8 of the mixing chamber faces the outer wall of the sleeve 30, and a retracted open position (FIG. 8 a)) in which the sleeve 30 leaves open at least part of the output opening of the mixing chamber so that output flow from the mixing chamber can enter an annular gap between the frusto-conical end face 38 of the sleeve 30 and the shoulder terminating the enlarged diameter end portion of the internal passageway of the delivery duct.

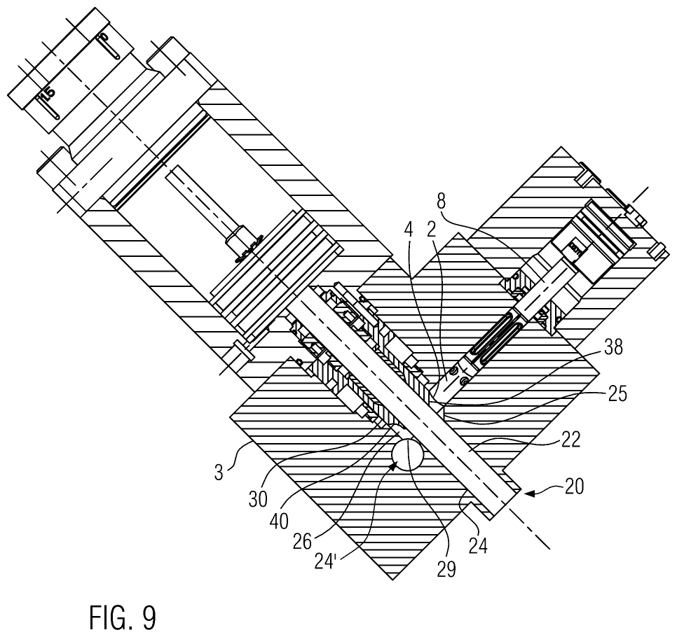

FIG. 9 shows a cross-section through the mixing head of the second embodiment taken in a plane in which the longitudinal axis of the delivery duct 20 extends and which is perpendicular to the longitudinal axis of the internal passageway 24′ of the alternate delivery duct. In the state illustrated in FIG. 9 the piston connected to the rod 22 of the delivery duct 20 is advanced such that the rod 22 extends along the internal passageway 24 to the output end of the delivery duct 20. In FIG. 9 the mixing spool 8 is retracted so that the mixing chamber 2 is communicating, via its output opening 4, with the gap between the frusto-conical end face 38 of the retracted sleeve 30 and the opposing annular shoulder 25 terminating, as spart of the mixing head body 3, the enlarged diameter end portion 26 of the internal passageway 24. The gap and the advanced rod 22 form an annular flow path around the circumferential surface of the rod 22 to the enlarged diameter end portion 26 on the opposite side which is in the region of the delivery duct opening 29 in flow communication with the internal passageway 24′ of the alternate delivery duct so that output flow from the output opening 4 flows through the gap formed in front of the retracted sleeve 30 and around the circumferential surface of the rod 22, and flows further through the delivery duct opening 29 into the internal passageway 24′ of the alternate delivery duct.

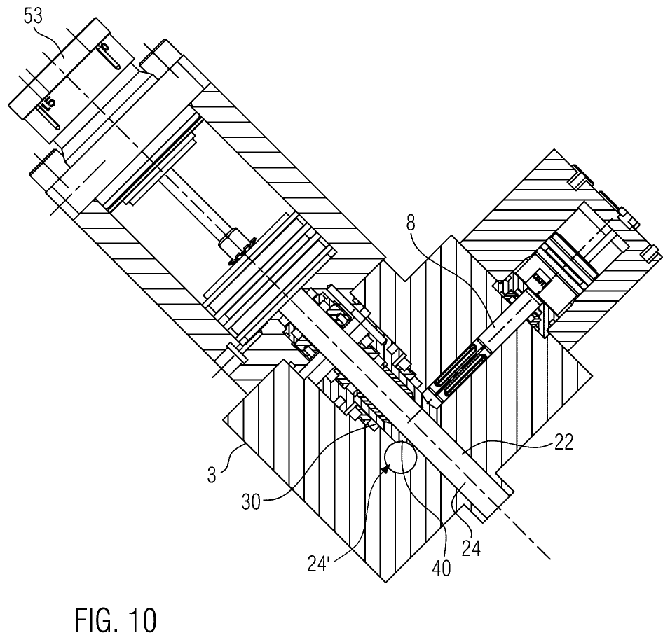

FIG. 10 shows a cross-sectional view of the same embodiment as in FIG. 9 but with the mixing spool closed and the sleeve 30 closed so to remove and expel the resin from the enlarged diameter portion, wherein the sleeve is closed after the mixing spool closed and before the rod 22 will close. In FIG. 10 the spool 8 is advanced to close the mixing chamber, and the sleeve 30 is advanced to its closing position (as in FIG. 8 b)) so that the frusto-conical end face of the sleeve 30 is in abutment on the complementary shaped annular shoulder terminating the enlarged diameter end portion, thereby completely closing the enlarged diameter end portion. In this state the advanced sleeve is with its recess 40 (see FIG. 9) moved to the delivery duct opening 29 (FIG. 9). As described before, the recess 40 in the front end face of the sleeve 30 has the purpose to avoid interferences between the sleeve 30 and the rod 22′ of the alternate delivery duct. In the state of FIG. 10 the mixing chamber is closed and no output flow exists the mixing chamber.

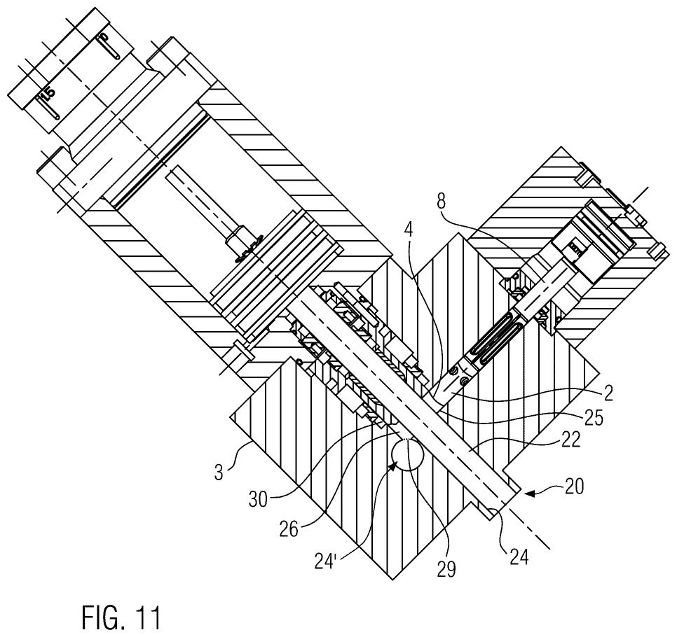

FIG. 11 is a cross-sectional view of a further modification of the second embodiment which differs from the versions of second embodiment described before in the shape of the inner end face of the sleeve which in this case is a planar annular end face of the sleeve 30 opposing the planar annular shoulder 25 terminating the enlarged diameter end portion 26 of the internal passageway of the delivery duct 20. Also in this modified version of the second embodiment output flow from the output opening 4 of the mixing chamber flows through the gap between the inner end face of the sleeve 30 and the annular shoulder 25, in arcuate flow paths around the circumferential surface of the advanced rod 22 of the delivery duct 20, and to the delivery duct opening 29 connecting the enlarged diameter end portion 26 with the internal passageway 24′ of the alternate delivery duct, thereby directing output flow from the mixing chamber 2 to the internal passageway 24′ of the alternate delivery duct.

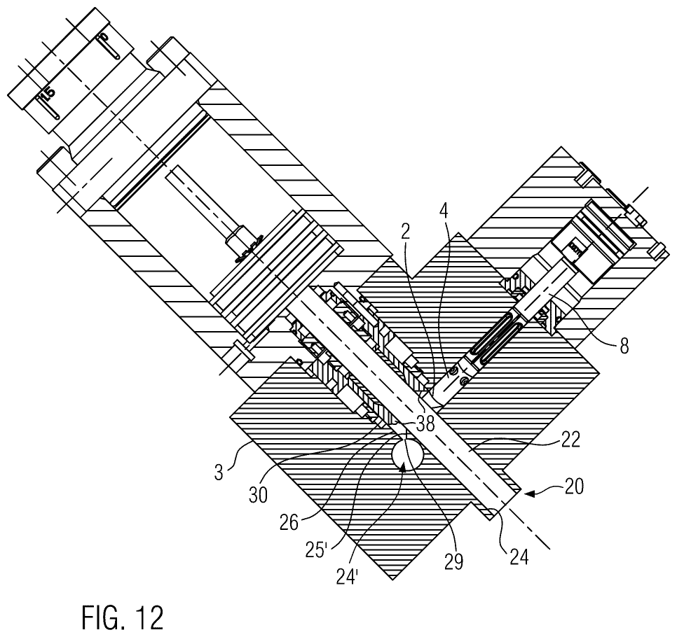

FIG. 12 is a cross-sectional view of a further modified version of the second embodiment, wherein in this case the annular shoulder terminating the enlarged diameter end portion 26 has an annular, frusto-conical shape, and the inner end face of the sleeve 30 is provided with an oppositely inclined, complementary inclined end face 38. In this manner a curved flow path through the gap formed between the end face 38 and the frusto-conical shoulder is formed as an annular flow channel around the circumferential surface of the rod 22 and further to delivery duct opening 29 the connecting the enlarged diameter end portion 26 with the internal passageway 24′ of the alternate delivery duct, thereby directing output flow from the mixing chamber 2 to the internal passageway 24′ of the alternate delivery duct.

In connection with the switching over the active output component from the delivery duct to the alternate delivery duct and vice versa, it is also possible and suitable to perform a cleaning operation of the volumes and ducts where reactive resins have flown before the switching to remove any cured polymeric coatings. After closing the mixing chamber 2 by advancing the spool 8, the control unit can be arranged to operate the actuator of the sleeve 30 to expel any resin residues form the an inclined gap 36 or from the gap between the frusto-conical end face 38 of the retracted sleeve 30 and the opposing shoulder 25, 25′, and to advance the rod 22 to move throughout the internal passageway 24 of the delivery duct in order to expel the residual resin and to clean it. Thereafter, the control units can retract the rod 22′ from the internal passageway 24′, reopen the sleeve 30 and retract the mixing spool 8 to start the delivery of resin in the alternate delivery duct. This operation requests less than 2 seconds and preferably around 1 second. In alternative it is possible simply to retract the rod 22′ of the alternate delivery duct 22′ and close immediately thereafter the delivery duct 20 advancing the rod 22. In this sequence the delivery of the resin to the surfaces of the substrate of the panel is not interrupted

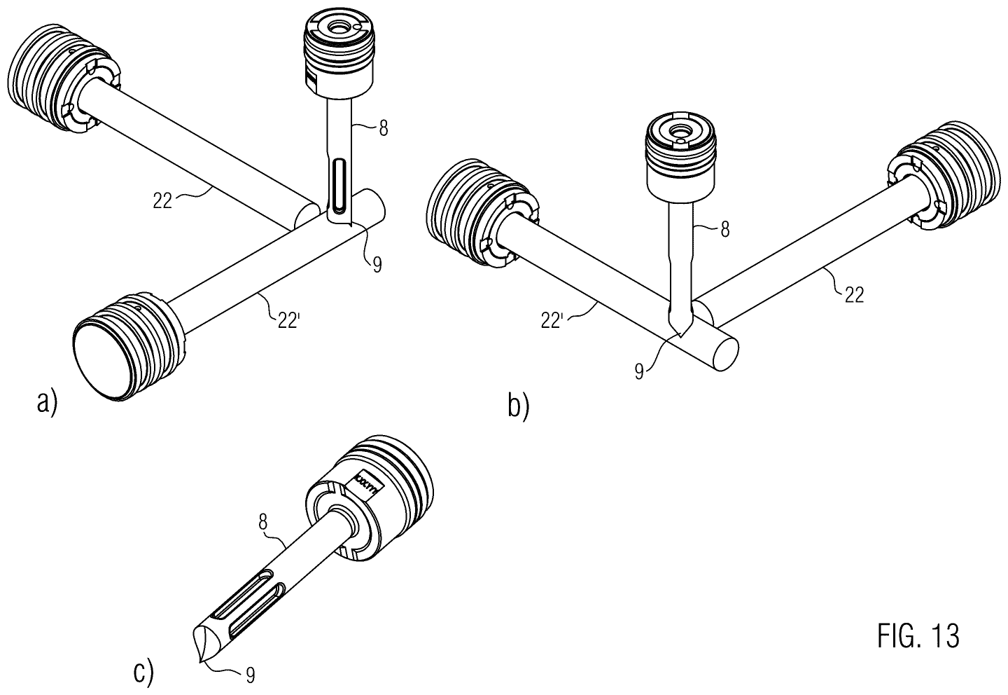

FIGS. 13 a) and b) show schematical perspective views from two different points of view of a third embodiment of a mixing head with a switchable flow connection. The configuration is illustrated by the rod 22 of the delivery duct, the rod 22′ of the alternate delivery duct, and by the spool 8 of the mixing chamber. In this embodiment the longitudinal axes of the internal passageways of the delivery duct and the alternate delivery duct extend in the same plane such that the internal passageways (surrounding the rods 22 and 22′) are crossing each other in a crossing zone forming a cylinder-cylinder intersection. The longitudinal axis of the mixing chamber is extending perpendicular to the plane of the delivery duct and the alternate delivery duct, wherein the mixing chamber is positioned such that its output opening is merging into the crossing zone of the internal passageways. The output opening of the mixing chamber is not centered with respect to the intersection point of the longitudinal axes of the delivery duct and the alternate delivery duct, but is displaced along the bisecting line of the 90° angle between the delivery duct and the alternate delivery duct towards the output ends of the delivery duct and the alternate delivery duct. This configuration implies that only one of the rods 22, 22′ can be advanced to extend through the crossing zone, in case of FIGS. 13 a) and b) the rod 22′ extends through the crossing zone, while the rod 22 can be advanced only up to the entry of the crossing zone.

The end surface of the mixing spool 8 opposite to the piston is shaped to fit to the cylinder-cylinder intersection of the crossing zone as can be seen in FIG. 13 c) which shows a perspective view the spool 8. The end surface of the spool has a central line separating two differently curved surface portions, wherein the central line corresponds to the line of the cylinder-cylinder intersection where the lateral surfaces of the two perpendicular cylinders meet, and each of the two adjacent surface portions corresponds to a lateral surface portion of one of the cylinders in the neighborhood of the cylinder-cylinder intersection. Since the longitudinal axis of the mixing chamber and of the spool is not centered on the intersection point of the longitudinal axes of the cylinders the end surface of the spool is not symmetrical and has an extension 9 which can also be seen in FIGS. 13 a) and b). This extension 9 is necessary to expel, when the mixing spool closes, all the resin from the mixing chamber and from the intermediate space between the mixing chamber and the two delivery ducts and it extends into the intermediate space where the two cylindrical passageways of the delivery duct and the alternate delivery duct merge into the crossing zone, wherein due to the displacement this extension is directed in the direction of the bisecting line of the angle between the delivery duct and the alternate delivery duct towards their output ends.

The shape of the end surface of the spool 8 is as described above for the case that the diameter of the mixing chamber opening is smaller than the diameter of the intersecting cylinders and that the longitudinal axis of the mixing chamber is displaced as described above, which is the preferred arrangement. In principle, another design is possible in which the diameter of the mixing chamber opening is larger than the diameter of the intersecting cylinders and in which the longitudinal axis of the mixing chamber is centered on the intersection point of the longitudinal axis of the intersecting cylinders, but this alternative arrangement will not be described in further detail herein.

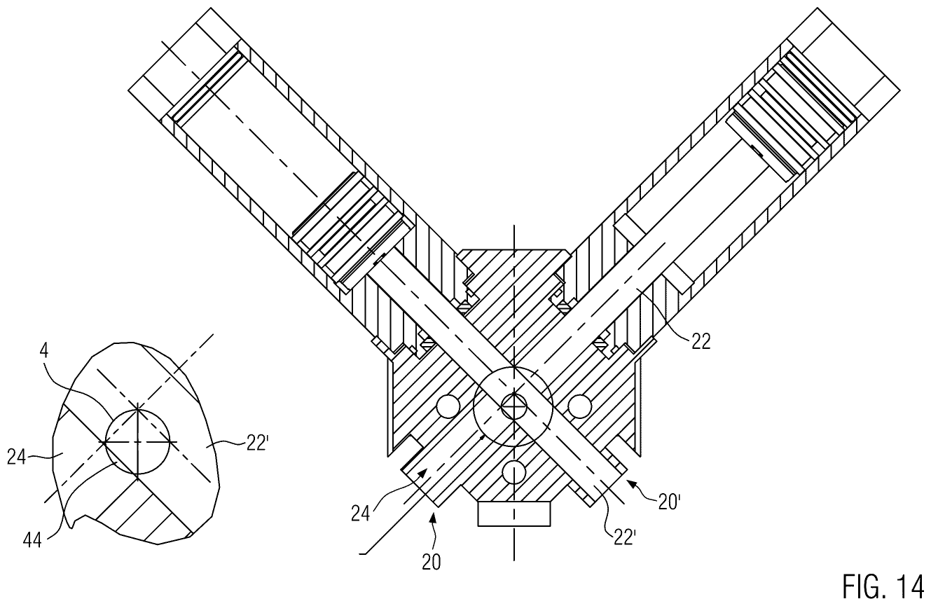

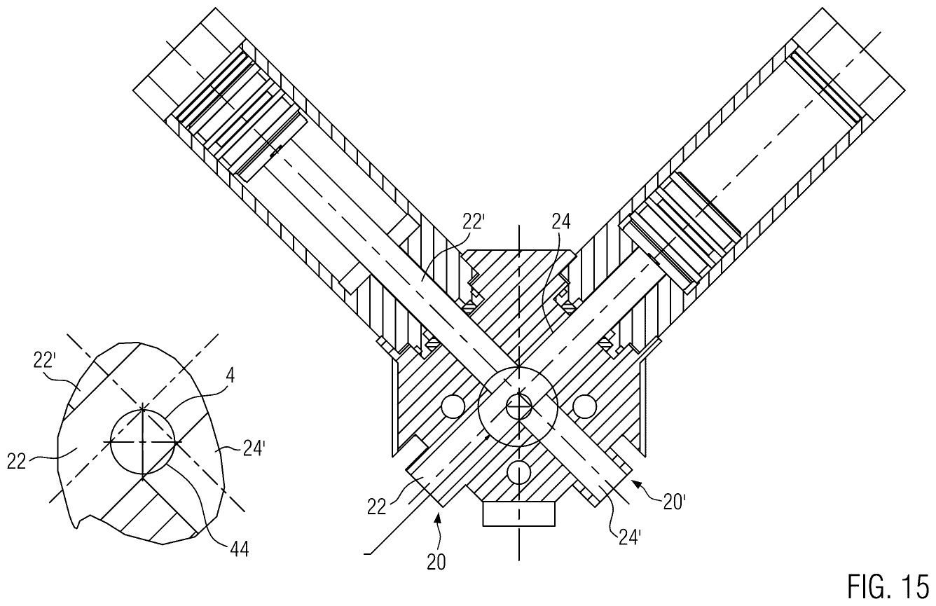

The design and operation of the third embodiment will be described with reference to the cross-sectional views of FIGS. 14 and 15. These cross-sectional views are taken in the plane in which the longitudinal axes of the internal passageways 24, 24′ extend. The mixing chamber extends perpendicular to the Figure plane above the Figure plane of FIGS. 14 and 15. The output opening 4 of the mixing chamber (see enlarged detail in FIGS. 14 and 15) merges into the crossing zone of the internal passageways 24, 24′, wherein the output opening 4 is not centered on the intersection point of the longitudinal axes of the internal passageways 24, 24′, but shifted with respect to this intersection point along the bisecting line of the 90° angle between the delivery duct 20 and the alternate delivery duct 20′ (which is a shift downwards in the views of FIGS. 14 and 15).

In the state of FIG. 14 the rod 22 of the delivery duct 20 is retracted so that it extends with its front end face only up to the crossing zone of the internal passageways 24, 24′, whereas the rod 22′ of the alternate delivery duct is advanced to extend through the crossing zone and up to the output end of the alternate delivery duct 20′. As shown in the enlarged detail on the left-hand side in FIG. 14, the displacement of the output opening 4 of the mixing chamber with respect to the crossing zone is such that a segment 44 of the cylinder-cylinder intersection forming the crossing zone of the internal passageways 24, 24′ is open for or overlapping with the output opening 4 of the mixing chamber. Consequently, in the state of FIG. 14 output flow on the output opening 4 of the mixing chamber flows through the segment 44 into the section of the internal passageway 24 beyond the crossing zone and further towards the output end of the delivery duct 20.

In the state of FIG. 15 the roles of the rods 22, 22′ are reversed, and in this case the rod 22′ of the alternate delivery duct 20′ is retracted so that it extends only up to the crossing zone, whereas the rod 22 of the delivery duct is advanced to extend through the crossing zone and up to the output end of the delivery duct 20. For this positioning of the rods 22, 22′ there is also a segment 44 of the cylinder-cylinder intersection forming the crossing of the internal passageways 24, 24′ which is open towards the output opening 4 of the mixing chamber, wherein in this case this segment 44 communicates with the section of the internal passageway 24′ of the alternate delivery duct so that output flow from the output opening 4 of the mixing chamber is directed to the internal passageway 24′ of the alternate delivery duct 20′ to flow towards its output end.

The switchable flow connection in this embodiment is formed by the crossing zone of the internal passageway 24, 24′ in cooperation with the displaced disposition of the output opening 4 of the mixing chamber with respect to the intersection point of the longitudinal axis of the internal passageways 24, 24′, wherein switching of the switchable flow connection is achieved by switching the positioning of the rod 22, 22′ from one of the rods 22, 22′ from extending through the crossing zone to the other of the rods 22, 22′ to extend through the crossing zone.

For example, for switching over delivery of the reactive mixture from being delivered through the delivery duct to delivery through the alternate delivery the following steps are performed. For the interruption of the delivery, the mixing spool 8 closes the mixing chamber, then the rod of the alternate delivery duct that is closed shall open so that the delivery duct, that was delivering the flow of resin and is also open, can be closed by advancing its rod which thereby expels residuals of resins, and then the mixing chamber can reopen to complete the switching of the flow to the alternate delivery duct.

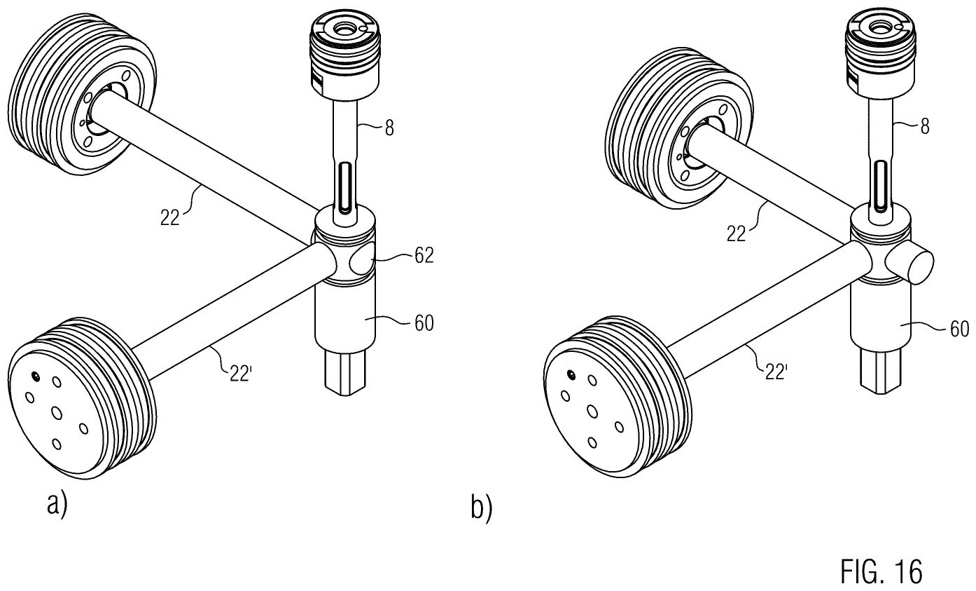

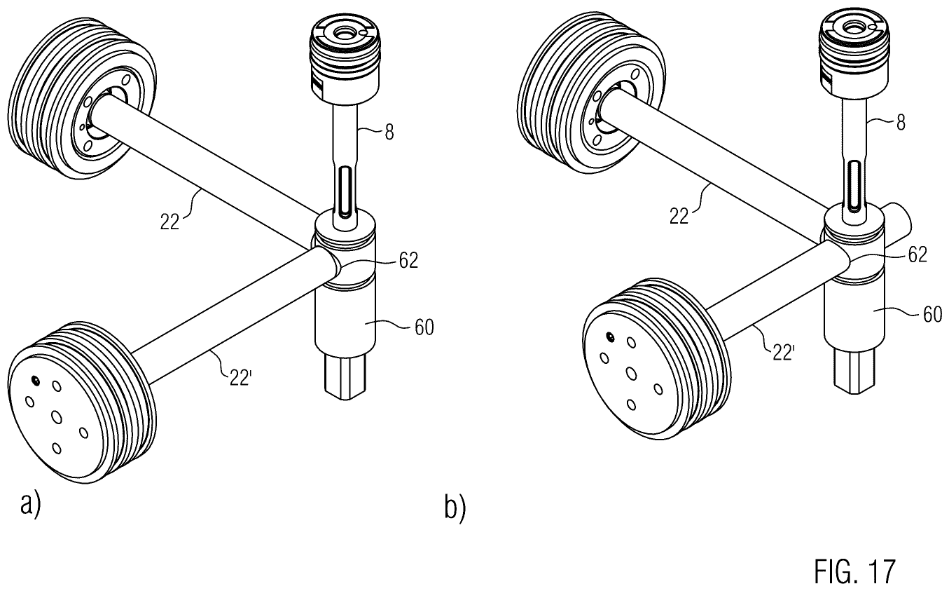

FIGS. 16 a) and b) and 17 a) and b) show schematical perspective views of a fourth embodiment of a mixing head with a switchable flow connection. Also in this embodiment the longitudinal axis of the internal passageway 24, 24′ (surrounding the rods 22, 22′ of the delivery duct and the alternate delivery duct) are extending in the same plane, and the mixing chamber is extending with its longitudinal axis perpendicular to the plane of the delivery duct and the alternate delivery duct. A cylindrical cavity intersects, with its cylinder axis extending perpendicular to the plane of the longitudinal axis of the delivery duct and the alternate delivery duct, with the intersection point of these longitudinal axes. In this cylindrical cavity a cylindrical flow diverter 60 is mounted as a part of the switchable flow connection with its cylinder axis coaxial with the cylinder axis of the cylinder cavity and of the mixing chamber. The cylindrical flow diverter is mounted in the cylindrical cavity to be rotatable about its cylinder axis, and it is with its cylinder axis aligned with the longitudinal axis of the mixing chamber. The cylindrical flow diverter 60 comprises a throughgoing transverse opening 62 forming in the state of FIGS. 16 a) and b) a continuation of the internal passageway in which the rod 22 of the delivery duct extends, so that the rod 22 can be advanced (see FIG. 16 b)) to move through the throughgoing transverse opening 62 of the cylindrical flow diverter 60 to expel the resin and clean the throughgoing transverse opening 62 and the delivery duct that is aligned with the throughgoing transverse opening 62. In the state of FIGS. 17 a) and b) the cylindrical flow diverter 60 has been rotated by 90° about its cylinder axis so that the throughgoing transverse opening 62 now forms a continuation of the internal passageway in which the rod 22′ of the alternate delivery duct.

The cylindrical flow diverter 60 further comprises an input opening which is communication with the output opening of the mixing chamber (in the views of FIGS. 16-17 a) and b) the input opening of the cylindrical flow diverter 60 is below the lower end face of the spool 8 of the mixing chamber). The input opening of the cylindrical flow diverter 60 is in flow communication with the throughgoing transverse opening 62 of the cylindrical flow diverter.

If the cylindrical flow diverter 60 is rotated such that its throughgoing transverse opening 62 is aligned with the internal passageway of one of the delivery duct and the alternate delivery duct, and the rod of this one of the delivery duct and the alternate delivery duct is retracted from extending through the throughgoing transverse opening, there is flow communication between the output of the mixing chamber, through the input opening, and the throughgoing transverse opening of the cylindrical flow diverter 60 further into the internal passageway of the one of the delivery duct and the alternate delivery duct.

For switching the switchable flow connection the cylindrical flow diverter 60 is rotated under control of the control unit to be aligned with the internal passageway of the other one of the delivery duct and alternate delivery duct, thereby switching the output flow from the output opening of the mixing chamber to flow into the internal passageway of the other one of the delivery duct and the alternate delivery duct.

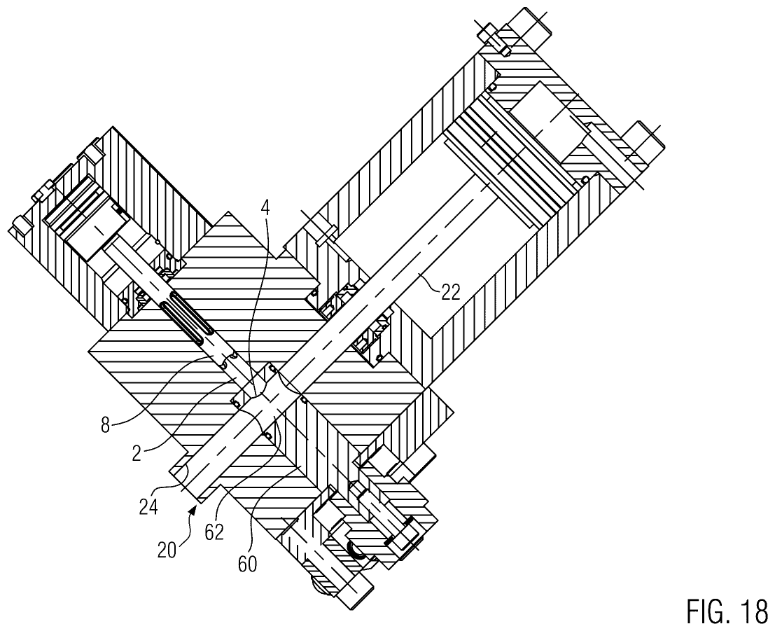

The design of the fourth embodiment of the mixing head is shown in more detail in the cross-sectional view of FIG. 18 which is taken in the plane in which the longitudinal axes of the internal passageway 24 of the delivery duct 20 and of the mixing chamber 2 extend. The spool 8 of the mixing chamber 2 is in the retracted position so that the mixing chamber 2 is open to form and eject polymeric mixture from its output opening 4. The output opening 4 of the mixing chamber is in flow communication with an input opening of the cylindrical flow diverter 60, which input opening in turn is in flow communication with the throughgoing transverse opening 62 of the cylindrical flow diverter 60. In the state illustrated in FIG. 18 the rod 22 of the delivery duct 20 is retracted such that it does not extend through the throughgoing opening 62 so that output flow from the mixing chamber 2 flows through the input opening of the cylindrical flow diverter 60 and further through the throughgoing transverse opening 62 of the cylindrical flow diverter 60 and into the aligned internal passageway 24 of the delivery duct.

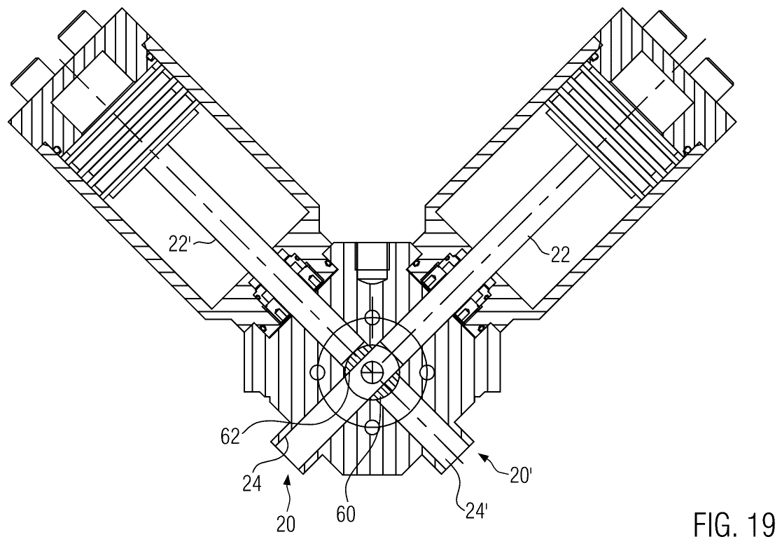

The cross-sectional view of FIG. 19 shows the same configuration and adjustment of the cylindrical flow diverter 60 in a cross-section taken in the plane defined by the longitudinal axes of the internal passageways 24, 24′. As can be seen in the cross-sectional view of FIG. 19 the throughgoing passageway 62 of the cylindrical flow diverter 60 is aligned with the internal passageway 24 of the delivery duct 20 so that output flow from the mixing chamber entering the input opening of the cylindrical flow diverter 60 is directed by the cylindrical flow diverter 60 to flow into the internal passageway 24 of the delivery duct 20.

To switch the switchable flow connection of this fourth embodiment of the mixing head, the spool 8 of the mixing chamber 2 is advanced to close the mixing chamber, the opened cleaning rod 22 is closed to expel the remaining resin form the internal passageway 24 and then re-opened, whereafter the cylindrical flow diverter 60 is rotated under the control of the control unit by 90° to align the throughgoing transverse opening 62 with the internal passageway 24′ of the alternate delivery duct 20′. Thereafter, the mixing chamber is activated again by retracting the spool 8 so that output flow from the output opening of the mixing chamber flows through the input opening and the throughgoing transverse passageway 62 of the cylindrical flow diverter 60 into the internal passageway 24′ of the alternate delivery duct 20′ to shift the flow from the delivery duct to the alternate delivery duct.

In connection with the above-described switching over it is also possible and suitable to perform a cleaning operation of the volumes and ducts where the reactive resins have flown before the switching. After closing the mixing chamber 2 by advancing the spool 8, the control unit can be arranged to operate the actuator of the rod 22 to advance the piston and the rod 22 to move the front end face of the rod 22 through the throughgoing transverse opening 62 and the adjoining section of the internal passageway 24 of the delivery duct in order to clean the throughgoing transverse opening 62 and the adjoining section of the internal passageway 24 of the delivery duct by pushing out any cured polymeric coatings from the throughgoing transverse opening 62 and the internal passageway 24. Thereafter, the control unit retracts the rod 22 again from the throughgoing transverse opening 62. Thereafter, the control unit can continue with the rotation of the cylindrical flow diverter to align the throughgoing transverse opening 62 with the internal passageway 24′ of the alternate delivery duct 20′.

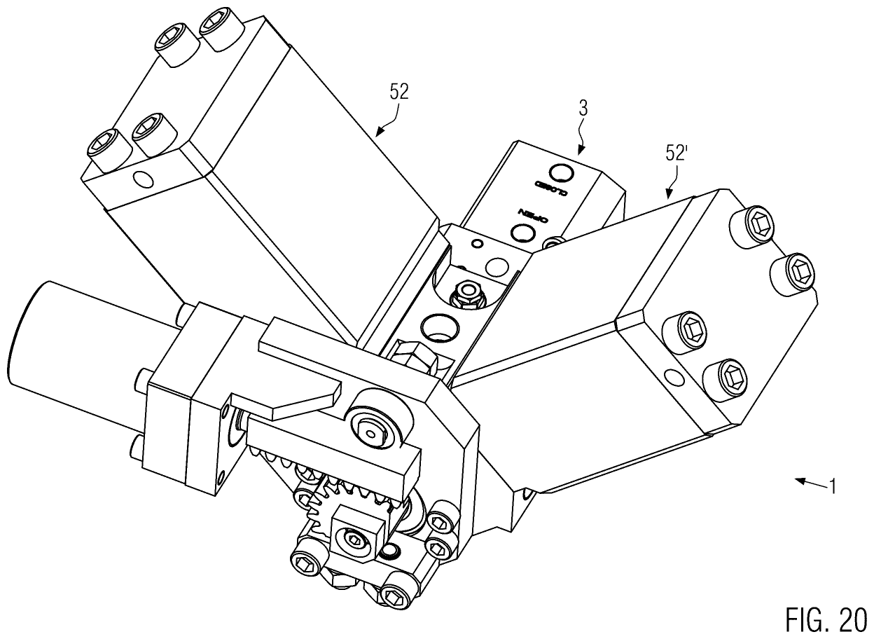

FIG. 20 shows an external view in axonometry of a mixing head according to the fourth embodiment. The mixing head 1 comprises the mix head body housing parts for the mixing chamber 2, the cylinders 52 and 52′ where the head piston 50 moves controlling the movement of the rod 22 sliding in the delivery duct 20 and of the rod 22′ sliding in the alternate delivery duct 20′. Also shown is a rotational actuator for rotating the cylindrical flow diverter between the aligned states with the internal passageways of the delivery duct and the alternate delivery duct. In the example shown the rotational actuator comprises a rack and pinion drive for driving the rotational movement of the cylindrical flow diverter between the aligned states with the delivery duct and the alternate delivery duct. However, also other kinds of rotational actuators can be used, for example a hydraulic motor, an electric motor and a gear box, etc.,

The switching of the output reactive polymeric mixture from the delivery ducts to the alternate delivery ducts is adopted to permit the replacement of the set of distributors 70 of the delivery ducts. The switching of the outputting ducts permits the replacement of the set of distributors 70 connected to the delivery ducts that have delivered the reactive mixture in the continuous production period before the before switching over output from the delivery ducts to the alternate delivery ducts.

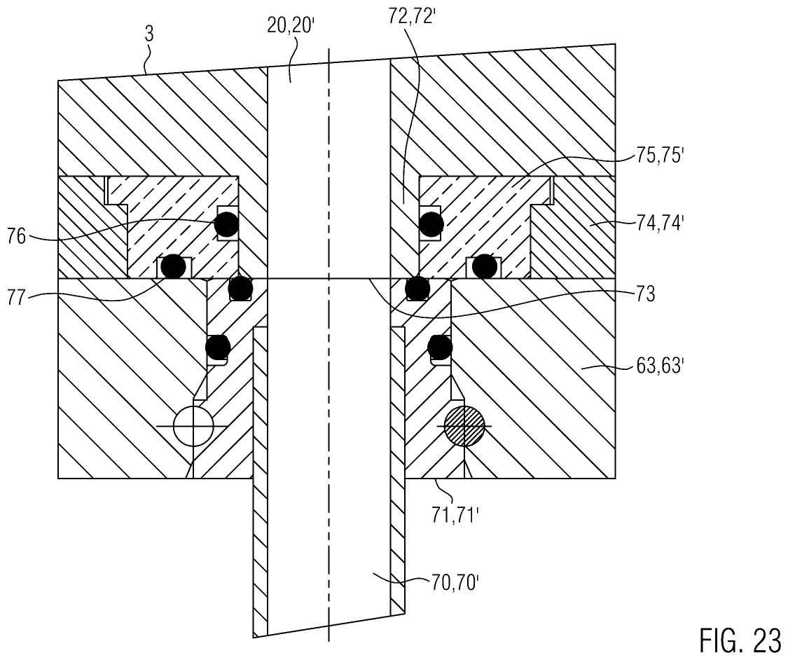

As already described in the introduction, the distributors can have various configurations to better distribute the resin on the substrate, as an example a distributor is considered that divides the outflow of resin into two flows before delivering it to the surface. As an example, the internal passageway 24 of the delivery duct 20 is continued in a sleeve 72 (see FIG. 23) attached to the mixing head body or machined directly as the output end of the delivery duct 20. The tubular end portion of the disposable plastic distributor 70 is connected to this sleeve and can be disconnected therefrom for replacement.

As already described in the introduction, the application of high-pressure mixing heads equipped with two crossed self-cleaning delivery ducts (delivery duct and alternate delivery duct) and a common mixing chamber, in continuous depositing of polymeric foam on a substrate advanced by a conveyor, makes it possible to avoid the application of two groups of mixing heads and the related supporting systems and the hydraulic and electric switching systems.

This configuration makes the best performance when complemented by a mechanism for the automatic replacement of distributors which are distributing the foam output from the delivery ducts on the advancing substrate. In the absence of automatic replacement mechanisms, the disposable distributors can in principle also be replaced manually by an expert operator without interrupting the supply, but this operation should be performed over the foam deposition area during foaming, or alternatively after stopping the operation mixings heads to proceed with the replacement of the distributors in safe conditions.

Two automatic systems that allow the automatic removal of the disposable distributors for their replacement in safe conditions and avoiding to stop the production are described below.

There are many types of distributors for polymeric mixtures, for example a type equipped with two branches of distribution ducts. However, the distributors can have three or more branches or can be shaped like tubes provided with many small holes placed in parallel, and many others which are part of the known art. It is as well known, that the distributors can be made of metal to be reused or of moulded plastic to be disposable.

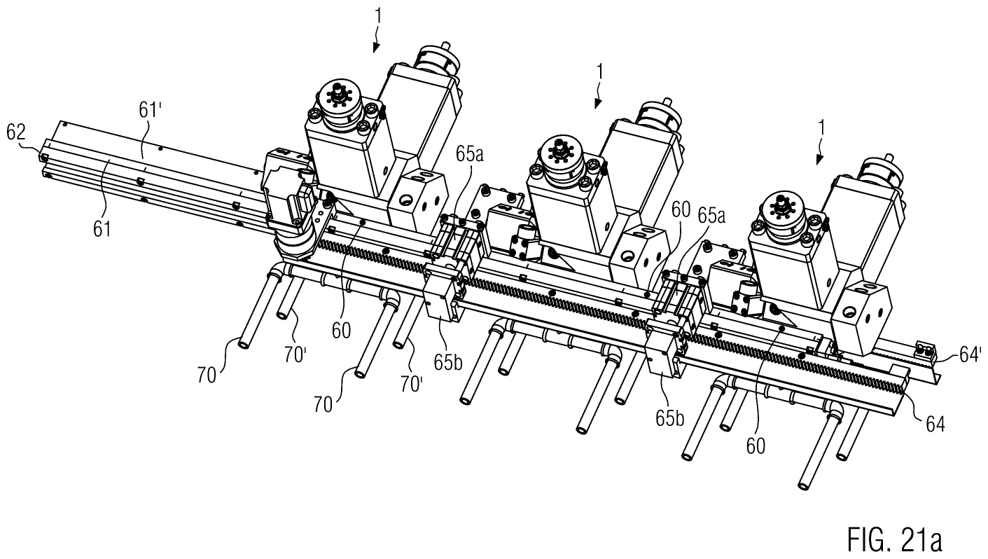

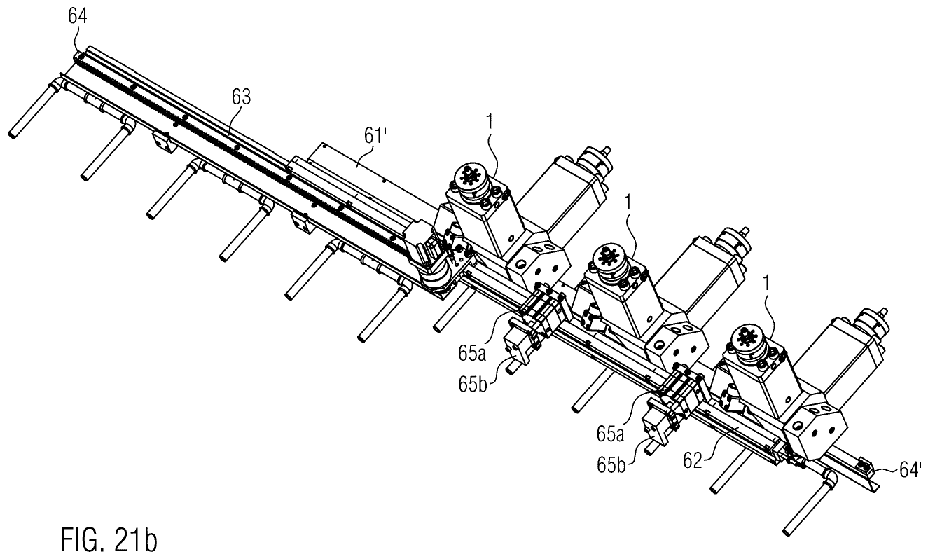

The three mixing head assembly of FIGS. 21a and 21b comprises of two sets (one per side) of three distributors 70 and 70′, wherein a first set is associated with the delivery ducts 20 and the other with the alternate delivery ducts 20′ of the three mixing heads 1. Each of the sets can be detached from the mixing heads and be displaced, in transverse direction to the conveying direction of the substrate on which the foam is deposited, to move it out of the region above the substrate for the automatic replacement of the distributors.

In FIGS. 21a and 21b a longitudinal structure is holding three mixing heads 1 configured each with two switchable delivery ducts, namely a delivery duct and an alternate delivery duct as in the embodiments described. The longitudinal structure comprises two longitudinal sides 60, 60′ extending along the range in which the three mixing heads 1 are disposed spaced apart from each other, and two lateral sections 61, 61′ outside the mixing head range. To the longitudinal sides 60, 60′ longitudinal guides 62, 62′ are fixed by which other two structures 63, 63′ (see also FIGS. 21a, 21b, 22 and 23) configured as bars 63, 63′ are guided to be slidably moved in transverse direction when racks 64, 64′ are driven. Each bar is holding one of the two sets of distributors 70, 70′ set in position by pneumatic actuators 65a, 65b by which the front end 71, 71′ of each distributor can be coupled/decoupled with/from the outlet end of the delivery ducts/alternate delivery ducts of the mixing heads 1.

In FIG. 21a the two sets of distributors 70, 70′ are shown positioned and coupled with the respective delivery ducts of the assembly of three mixing heads 1 mounted in parallel. The mixing heads 1 are represented without the connection hoses and just with the blocks for the hose's connection on their sides.

In FIGS. 21a and 21b are also shown the two pneumatic actuators 65a fixed to each of the two sliding frames and spaced in position to stop in front of the respective delivery duct to which each actuator, by means of a clamping or inserting device 65b can hold each disposable distributor and pull or insert the entrance end of each distributor against or around the outlet end of the delivery duct/alternate delivery duct. When the front end of the delivery duct of the mixing head is flat the entrance of the distributor can be pulled against a flat surface, while, when it is configured as a sleeve, the entrance end of the disposable distributor can be inserted/disinserted around it. An extraction and sealing arrangement 71, 71′ permits to extract the three disposable distributors outside the foaming zone while the other three are continuing the foaming.

A transversal extraction movement permits to shift the position of the holding bars 63, 63′, each holding a set of three distributors 70 or 70′, to move a set of three disposable distributors away from the foaming zone. Each extraction rack 64, 64′ is equipped with an electrical or hydraulic or pneumatic driven motor that controls its lateral extraction according to a movement parallel to the arrangement of the mixing heads. Each of the two racks 64, 64′ is connected to one of the holding bars 63, 63′ that slide along guides 62, 62′ applied to the frame fixing the mixing heads. Other types of extraction actuators can be utilized, such as axial actuators that are hydraulically, electrically or pneumatically controlled.

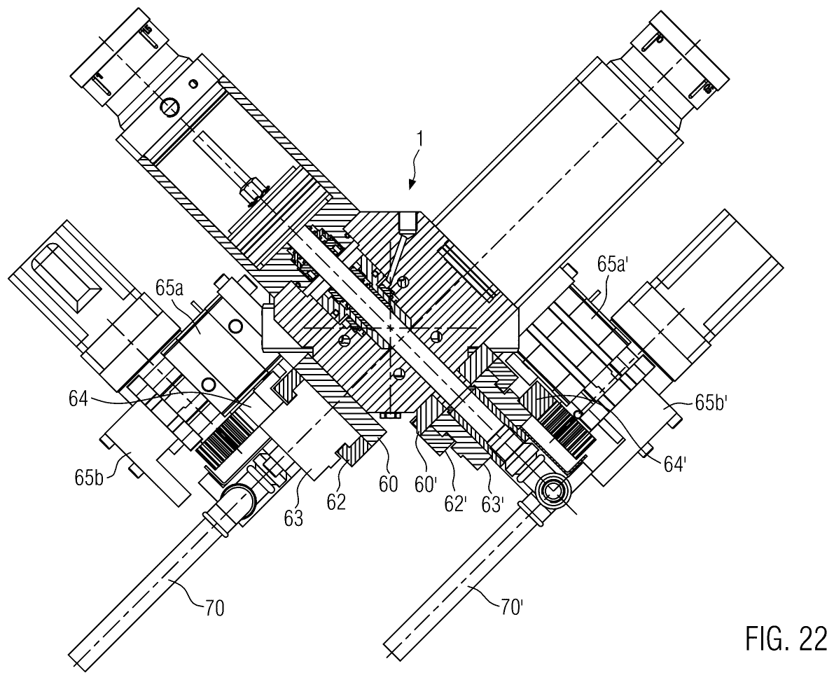

In FIG. 22 guides and pads are configured as a simple sliding mechanism. But the guides and pads can also slide on brass bushes or Teflon pads or on shaped rollers or on recirculating ball bearing pads. FIG. 22 shows that one of the types of distributor has an axial supply while the other which has the same dispensing inclination requesting the addition of a perpendicular part of disposable duct. The disposable distributors 70, 70′, taken as an example, are equipped with two channels which divide the flow of each head in two and all are oriented in the direction of movement of the flexible containment substrate of the panel (normally paper reinforced with some fibre) on which they dispense the polymeric mixture.

FIG. 23 is an enlarged cross-section of a sliding connection between the front (outlet) end of the mixing head sleeve 72, 72′ and the entrance end 73, 73′ of the disposable distributor 70, 70′. The disposable distributor 70, 70′ is glued to a sealing sleeve 71, 71′ provided with seals that seal the connection with the sliding structures 63, 63′ that hold the distributors and permit to shift them from the connection position to the lateral extraction position, and with the front of the mixing head sleeve 72, 72′ at the exit of the delivery duct 20, and the alternate delivery duct 20′. A plastic part 75, 75′, made of slidable plastic, encircles the mix head sleeve 72, 72′ and is provided with a circular drill fitting with the mixing head sleeve 72, 72′ and with a circular seal 76, and a front seal 77. It is connected to the mixing head body by a bracketing part 74, 74′. When the disposable distributor shall be replaced, the rod 22 closes the delivery duct and expels the reactive resins from the delivery duct 20 up to the front of the replaceable sleeve connected to the distributor forming a flat surface against which the sliding parts can slide for the extraction movement eventually waiting that the reactive resin becomes polymerized inside the disposable distributor parts.

1. A high pressure mixing head for continuously producing polymeric foam, comprising
a body including a mixing chamber and injectors for injecting at least two polymeric liquids, wherein a spool is moveable in the mixing chamber in a longitudinal direction thereof between a retracted position in which the injectors are able to inject jets of polymeric liquids into the mixing chamber to be mixed under turbulent conditions so that a reactive polymeric mixture is expelled from an output opening of the mixing chamber, and an advanced position in which the spool is advanced in the mixing chamber beyond the injectors and the polymeric liquids from the injectors are returned to be recycled via recycling channels, and
a delivery duct which is disposed transversely to the mixing chamber, wherein a rod is slidably received in an internal passageway of the delivery duct and is connected to a piston of an actuator configured to move the rod along a longitudinal axis of the delivery duct between a retracted position in which the internal passageway along the delivery duct is in flow communication with the mixing chamber to receive the reactive polymeric mixture expelled from the output opening for conveying the reactive polymeric mixture along the internal passageway and into a distributor connected to an output end of the delivery duct for dispensing the polymeric foam resulting from the reactive polymeric mixture, and an advanced position in which the rod is moved all along the internal passageway for cleaning the internal passageway, wherein the rod is of complementary cross-sectional shape to the internal passageway of the delivery duct so that the rod closes the internal passageway up to the position the rod is moved to,
wherein an alternate delivery duct extends transversely to the delivery duct and to the mixing chamber, and wherein the delivery duct and the alternate delivery duct are in flow communication with the mixing chamber via a switchable flow connection, and a control unit is configured to control the switchable flow connection and the positions of the rods in the delivery duct and the alternate delivery duct such that flow from the output opening of the mixing chamber can be selectively directed either to the delivery duct or to the alternate delivery duct.

2. The high pressure mixing head according to claim 1, wherein the switchable flow connection is formed by an enlarged diameter end portion of the internal passageway of the delivery duct and by a sleeve slidably received therein, wherein the enlarged diameter end portion extends from the end of the delivery duct opposite to the output end and extends along the internal passageway beyond the output opening of the mixing chamber such that the enlarged diameter end portion is in flow communication with the output opening of the mixing chamber, wherein the sleeve received in the enlarged diameter end portion has an internal diameter equal and fitting to the internal diameter of the remaining internal passageway of the delivery duct and wherein the sleeve is movable within the enlarged diameter end portion between a closing position in which the sleeve covers the output opening of the mixing chamber and a retracted open position in which the sleeve leaves open at least part of the output opening of the mixing chamber to allow flow from the mixing chamber into the enlarged diameter end portion, and in that the longitudinal axes of the delivery duct and the alternate delivery duct do not extend in in a common plane, but are shifted, in a direction perpendicular to the longitudinal axes of the delivery duct and the alternate delivery duct, with respect to each other to such extent that the enlarged diameter end portion of the delivery duct and the internal passageway of the alternate delivery duct intersect, thereby forming a delivery duct opening for flow communication between the enlarged diameter end portion of the delivery duct and the internal passageway of the alternate delivery duct, such that when the control unit controls the positioning of the sleeve to be in the open position, output from the mixing chamber is directed to the delivery duct by positioning the rod of the delivery duct to open the internal passageway of the delivery duct and by positioning the rod of the alternate delivery duct to close the internal passageway of the alternate delivery duct, whereas output from the mixing chamber is directed to the alternate delivery duct by positioning the rod of the alternate delivery duct to open the internal passageway of the alternate delivery duct and by positioning the rod of the delivery duct to close the internal passageway of the delivery duct.

3. The high pressure mixing head according to claim 2, wherein the delivery duct opening is located, in flow direction through the delivery duct, downstream of the output opening of the mixing chamber.

4. The high pressure mixing head according to claim 3, wherein the sleeve has an inclined inner end face and a longitudinal inner end region of the enlarged diameter end portion is provided with an oppositely inclined end face facing the inclined end face of the sleeve such that, when the sleeve is moved to the closing position, the inclined end face is in abutment on the oppositely inclined end face of the inner end region and such that, when the sleeve is moved to the retracted open position, an inclined gap is formed between the inclined inner end face of the sleeve and the oppositely inclined end face of the inner end region, which inclined gap forms, when the rod of the delivery duct is closing the internal passageway, an inclined annular flow path from the output opening of the mixing chamber, around the rod of the delivery duct to the delivery duct opening and into the internal passageway of the alternate delivery duct.

5. The high pressure mixing head according to claim 4, wherein the retracted position of the rod of the delivery duct is adjustable to a partial closing position in which a front end face of the rod of the delivery duct is located downstream of the mixing chamber output opening and within the inner end region of the enlarged diameter end portion, such that, when the sleeve is in the retracted open position, and when the rod of the delivery duct is in the partial closing position and the rod of the alternate delivery duct is in the advanced position closing the internal passageway, fluid flow from the output opening of the mixing chamber is flowing through the inclined gap around the rod of the delivery duct and into the inner end region of the enlarged diameter end portion and from there continues into the adjoining internal passageway of the delivery duct.

6. The high pressure mixing head according to claim 3, wherein the sleeve has a frustoconical end face that can be either outwardly inclined or inwardly inclined, such that between the frustoconical end face and an annular complementary frustoconical shoulder terminating the enlarged diameter end portion of the internal passageway of the delivery duct, when the sleeve is in the retracted open position, an annular gap is formed, which annular gap forms, when the rod of the delivery duct is closing the internal passageway of the delivery duct, an annular flow path around the rod of the delivery duct from the output opening of the mixing chamber to the delivery duct opening and into the internal passageway of the alternate delivery duct, or in that the sleeve has a flat end face such that between the flat end face and an complementary flat annular shoulder terminating the enlarged diameter end portion of the internal passageway of the delivery duct an annular gap is formed, which annular gap forms, when the rod of the delivery duct is closing the internal passageway of the delivery duct, an annular flow path around the rod of the delivery duct from the output opening of the mixing chamber to the delivery duct opening and into the internal passageway of the alternate delivery duct.

7. The high pressure mixing head according to claim 2, wherein the inner end face of the sleeve is provided with a recess of complementary shape to a portion of the surface of the rod of the alternate delivery duct projecting through the delivery duct opening into the enlarged diameter end portion of the internal passageway of the delivery duct when the rod of the alternate delivery duct is closing the internal passageway of the alternate delivery duct such that movement of the sleeve to the closing position is not obstructed and such that the projecting portion of the rod of the alternate delivery duct is received in the recess of the inner end face of the sleeve when the sleeve reached the closing position.

8. The high pressure mixing head according to claim 2, wherein the sleeve is connected to a pneumatic or hydraulic actuation piston for selectively moving the sleeve between the retracted position and the closing position under the control of the control unit, wherein the sleeve, when moved from the retracted open position to the closing position, acts as a cleaning member for the enlarged diameter end portion of the internal passageway to expel any resin residues to the delivery duct or alternate delivery duct.

9. The high pressure mixing head according to claim 1, wherein the delivery duct and the alternate delivery duct are extending with their longitudinal axes in the same plane such that the internal passageways of the delivery duct and the alternate delivery duct are crossing each other in a crossing zone, and in that the longitudinal axis of the mixing chamber is inclined by less than 20° with respect to a normal of the plane of the delivery duct and the alternate delivery duct, such that the output opening of the mixing chamber is merging into the crossing zone of the internal passageways of the delivery duct and the alternate delivery duct, wherein the output opening of the mixing chamber is not centered with respect to the intersection point of the longitudinal axes of the delivery duct and the alternate delivery duct, but the output opening is displaced along the bisecting line of the 90° angle between the delivery duct and the alternate delivery duct towards the output ends of the delivery duct and the alternate delivery duct to form an overlapping portion of the output opening of the mixing chamber with the internal passageway of each of the delivery duct and the alternate delivery duct to form the switchable flow connection that directs flow from the output opening of the mixing chamber around the rod of the alternate delivery duct into the internal passageway of the delivery duct beyond the crossing zone when the rod of the alternate delivery duct is positioned to extend through the crossing zone and the rod of the delivery duct is positioned to extend up to the rod of the alternate delivery duct, and that directs output flow from the mixing chamber around the rod of the delivery duct into the internal passageway of the alternate delivery duct beyond the crossing zone, when the rod of the delivery duct is positioned to extend through the crossing zone and the rod of the alternate delivery duct is positioned to extend up to the rod of the delivery duct.

10. The high pressure mixing head according to claim 9, wherein the longitudinal axis of the mixing chamber is extending in a plane that is perpendicular to the plane of the delivery duct and the alternate delivery and that includes the bisecting line between delivery duct and the alternate delivery duct.

11. The high pressure mixing head according to claim 9, wherein the delivery duct and the alternate delivery duct are extending with their longitudinal axes in the same plane with their longitudinal axes forming an angle of 90°+20° with each other.

12. The high pressure mixing head according to claim 9, wherein the displacement of the output opening of the mixing chamber with respect to the intersection point of the longitudinal axes of the delivery duct and the alternate delivery duct and the diameters of the output opening of the mixing chamber and of the internal passageways of the delivery duct and the alternate delivery duct are such that, when the rod in the delivery duct extends through the crossing zone, a segment of the cylinder-cylinder intersection forming the crossing zone of the internal passageways is open for the output opening of the mixing chamber and communicating with the internal passageway section of the alternate delivery duct beyond the crossing zone, and such that, when the rod in the alternate delivery duct extends through the crossing zone, a segment of the cylinder-cylinder intersection is open for the output opening of the mixing chamber and communicating with the internal passageway section of the delivery duct beyond the crossing zone.

13. The high pressure mixing head according to claim 1, wherein the delivery duct and the alternate delivery duct are extending with their longitudinal axes in the same plane, and wherein a cylindrical cavity intersects, with a cylinder axis of the cavity extending perpendicular to the plane defined by the longitudinal axes of the delivery duct and the alternate delivery duct, with the intersection point of both longitudinal axes, wherein a cylindrical flow diverter, as part of the switchable flow connection, is located in the cylindrical cavity with a cylinder axis of the cylindrical flow diverter coaxial with the cylinder axis of the cylindrical cavity, wherein the cylindrical flow diverter is rotatable around the cylinder axis of the cylindrical flow diverter and is with the cylinder axis of the cylindrical flow diverter aligned with the longitudinal axis of the mixing chamber and wherein the cylindrical flow diverter comprises a throughgoing transverse opening forming a continuation of the internal passageway of the delivery duct and of the alternate delivery duct, respectively, wherein the flow diverter is, under control of the control unit, rotatable so that the throughgoing transverse opening is aligned with the internal passageway of delivery duct and of the alternate delivery duct, respectively, the cylindrical flow diverter further comprising an input opening which is in communication with the output opening of the mixing chamber and which communicates with the throughgoing transverse opening, such that, when the rods of the delivery duct and the alternate delivery duct are retracted to keep the throughgoing transverse opening open for fluid flow from the input opening to the throughgoing transverse opening, the switchable flow connection is delivering output flow from the mixing chamber to the delivery duct when the cylindrical flow diverter is rotated to be, with the throughgoing transverse opening, aligned with the internal passageway of the delivery duct, and such that the switchable flow connection is delivering output flow from the mixing chamber to the alternate delivery duct when the cylindrical flow diverter is rotated to be, with the throughgoing transverse opening, aligned with the internal passageway of the alternate delivery duct.

14. The high pressure mixing head according to claim 13, wherein the throughgoing transverse opening of the flow diverter has an inner diameter equal and fitting to the inner diameter of the internal passageways the delivery duct and the alternate delivery duct such that, when the throughgoing transverse opening is aligned with the internal passageway of the delivery duct and the alternate delivery duct, respectively, the rod of the delivery duct and the alternate delivery duct, respectively, can be advanced under the control of the control unit to move through the throughgoing transverse opening and the remaining part of the internal passageway of the delivery duct and of the alternate delivery duct, respectively, to expel reactive polymeric mixture and residuals therefrom for cleaning purposes, before the control unit retracts the respective rod to allow rotation of the cylindrical flow diverter to an alignment position with the internal passageway of the delivery duct or the alternate delivery duct.

15. The high pressure mixing head according to claim 13, wherein the cylindrical cavity has a cross-sectional shape complementary to the cross-section of the cylindrical flow diverter.

16. A method for continuously producing polymeric foam using a high pressure mixing head comprising:
a body including a mixing chamber and injectors for injecting at least two polymeric liquids, wherein a spool is moveable in the mixing chamber in a longitudinal direction thereof between a retracted position in which the injectors are able to inject jets of polymeric liquids into the mixing chamber to be mixed under turbulent conditions so that a reactive polymeric mixture is expelled from an output opening of the mixing chamber, and an advanced position in which the spool is advanced in the mixing chamber beyond the injectors and the polymeric liquids from the injectors are returned to be recycled via recycling channels, and
a delivery duct which is disposed transversely to the mixing chamber, wherein a rod is slidably received in an internal passageway of the delivery duct and is connected to a piston of an actuator configured to move the rod along a longitudinal axis of the delivery duct between a retracted position in which the internal passageway along the delivery duct is in flow communication with the mixing chamber to receive the reactive polymeric mixture expelled from the output opening for conveying the reactive polymeric mixture along the internal passageway and into a distributor connected to an output end of the delivery duct for dispensing the polymeric foam resulting from the reactive polymeric mixture, and an advanced position in which the rod is moved all along the internal passageway for cleaning the internal passageway, wherein the rod is of complementary cross-sectional shape to the internal passageway of the delivery duct so that the rod closes the internal passageway up to the position the rod is moved to,
wherein an alternate delivery duct extends transversely to the delivery duct and to the mixing chamber, and wherein the delivery duct and the alternate delivery duct are in flow communication with the mixing chamber via a switchable flow connection, and a control unit is configured to control the switchable flow connection and the positions of the rods in the delivery duct and the alternate delivery duct such that flow from the output opening of the mixing chamber can be selectively directed either to the delivery duct or to the alternate delivery duct, the method comprising:
during a first phase of a continuous production run, setting the switchable flow connection of the high pressure mixing head to direct polymeric mixture expelled from the mixing chamber through the delivery duct for dispensing the polymeric foam resulting from reactive polymeric mixture through the distributor onto a moving substrate below the distributor,
for terminating the first phase and for initiating a second alternate phase of the continuous production run, switching the switchable flow connection and the positions of the rods in the delivery duct and the alternate delivery duct over such that flow from the output opening of the mixing chamber is directed to the alternate delivery duct to thereby immediately switch over to the alternate delivery duct as active output component for dispensing the polymeric foam through the through distributor of the alternate delivery duct onto the moving substrate for continuing the continuous production run in the second phase, and
during the second phase of the production run, cleaning the delivery duct and cleaning or replacing a distributor of the delivery duct.

17. A polymeric foam distribution system including:
a conveyor configured to transport a substrate in a transport direction; and
a multiple mixing head assembly comprising at least two high pressure mixing heads, wherein in each mixing head includes
a body including a mixing chamber and injectors for injecting at least two polymeric liquids, wherein a spool is moveable in the mixing chamber in a longitudinal direction thereof between a retracted position in which the injectors are able to inject jets of polymeric liquids into the mixing chamber to be mixed under turbulent conditions so that a reactive polymeric mixture is expelled from an output opening of the mixing chamber, and an advanced position in which the spool is advanced in the mixing chamber beyond the injectors and the polymeric liquids from the injectors are returned to be recycled via recycling channels, and
a delivery duct which is disposed transversely to the mixing chamber, wherein a rod is slidably received in an internal passageway of the delivery duct and is connected to a piston of an actuator configured to move the rod along a longitudinal axis of the delivery duct between a retracted position in which the internal passageway along the delivery duct is in flow communication with the mixing chamber to receive the reactive polymeric mixture expelled from the output opening for conveying the reactive polymeric mixture along the internal passageway and into a distributor connected to an output end of the delivery duct for dispensing the polymeric foam resulting from the reactive polymeric mixture, and an advanced position in which the rod is moved all along the internal passageway for cleaning the internal passageway, wherein the rod is of complementary cross-sectional shape to the internal passageway of the delivery duct so that the rod closes the internal passageway up to the position the rod is moved to,
wherein an alternate delivery duct extends transversely to the delivery duct and to the mixing chamber, and wherein the delivery duct and the alternate delivery duct are in flow communication with the mixing chamber via a switchable flow connection, and a control unit is configured to control the switchable flow connection and the positions of the rods in the delivery duct and the alternate delivery duct such that flow from the output opening of the mixing chamber can be selectively directed either to the delivery duct or to the alternate delivery duct,
the multiple mixing head assembly comprising a mounting frame including a longitudinal structure on which the mixing heads are mounted spaced apart from each other in a linear arrangement extending transversely to the transport direction of the substrate, wherein each of the mixing heads is arranged on the longitudinal structure to deliver a part of the polymeric foam that forms a foam layer on the advancing substrate, thereby distributing the foam in a direction transverse to the transport direction of the substrate, wherein the multiple mixing head assembly is further provided with a distributor replacement mechanism for detaching a set of distributors which are associated with one of the delivery ducts and the alternate delivery ducts of the mixing heads and for moving the detached set of distributors in a transverse direction to the transport direction of the substrate out of the zone above the substrate to allow replacement of the distributors while production continues utilizing the other one of the delivery ducts and the alternate delivery ducts for delivering polymeric foam.

18. A polymeric foam distribution system according to claim 17, wherein the distributor replacement mechanism comprises two subassemblies, one for the replacement of the set of distributors of the delivery ducts of the mixing heads and one for the replacement of the set of distributors of the alternate delivery ducts, wherein the two subassemblies comprise two longitudinal sides extending along the range which is covered by the spaced apart mixing heads and along a lateral length section beyond the range covered by the mixing heads, wherein longitudinal guides are fixed to each of the longitudinal sides, wherein each of the longitudinal guides slidably guides one of the two holding slidable structures formed as bars for moving in transverse direction, each holding slidable structure holding the inlet ends of the set of distributors of one of the delivery ducts and the alternate delivery ducts in the appropriate spacing along the respective holding slidable structure so that the inlet ends of the set of distributors can be aligned with the output ends of the delivery ducts or alternate delivery ducts, wherein the distributor replacement mechanism comprises an axial actuator for sliding one of the holding slidable structures guided by the longitudinal guides from an operating position in which the inlet ends of the set of distributors is aligned with the output ends of one of the delivery ducts and alternate delivery ducts, respectively, to a transversely displaced service position outside of the area above the foam deposition on the substrate.

19. A polymeric foam distribution system according to claim 18, wherein the distributor replacement mechanism further comprises clamping or inserting devices by which the input ends of each of the two sets of distributors can be decoupled/coupled with the front end of the delivery ducts and the alternate delivery ducts of the mixing heads.

20. A polymeric foam distribution system according to claim 17, wherein the distributor replacement mechanism is provided with a sliding connection between the output end of the delivery ducts and of the alternate delivery ducts and the inlet ends of the distributors, wherein the distributors are glued to a sealing sleeve provided with seals that seal the connection with the slidable holding bars, each holding one of the two sets of distributors and permitting to shift the set from the operation position to the transversely displaced service position and to shift them back to the operation position with the inlet ends of the distributors aligned with the output ends of the delivery ducts and alternate delivery ducts, respectively, wherein the distributor replacement mechanisms further comprises a sliding part encircling the sleeve at the output end of the delivery ducts and alternate delivery ducts by a circular drill fitting and with a circular seal and a front seal.
